(19) United States
(12) Patent Application Publication
(10) Pub. No.: US 2020/0242146 A1
(43) Pub. Date: Jul. 30, 2020

(54) ARTIFICIAL INTELLIGENCE SYSTEM FOR GENERATING CONJECTURES AND COMPREHENDING TEXT, AUDIO, AND VISUAL DATA USING NATURAL LANGUAGE UNDERSTANDING

(71) Applicant: Andrew R. KALUKIN, Arlington, VA (US)

(72) Inventor: Andrew R. KALUKIN, Arlington, VA (US)

(21) Appl. No.: 16/697,456

(22) Filed: Nov. 27, 2019

Related U.S. Application Data
(63) Continuation-in-part of application No. 16/256,089, filed on Jan. 24, 2019, now Pat. No. 10,628,743.

(51) Int. Cl. G06F 16/332; G06F 17/27; G06N 3/04; G06N 5/04

(52) U.S. Cl. CPC G06F 16/3329; G06N 5/041; G06N 3/04; G06F 17/279

(57) ABSTRACT

A robotic system for processing input, such as text data provided through a messaging system, spoken language data provided through a microphone, or any other such input data, which may function to process the input so as to be able to respond or reply to a user based on comprehension of the input sentences. An automated theorem prover (ATP) or similar inference engine technology may operate as an underlying framework for the Artificial Intelligence (AI) system that understands and responds to spoken or written statements translated into a proper format. An ATP formatter may be used to translate natural language processing (NLP) output from an NLP syntactical sentence parser into the proper format, such that the ATP system may be able to generate and populate an ontology or knowledge base from the NLP output. User queries may be mapped to this ontology in order to facilitate comprehension.

### CROSS-REFERENCE TO RELATED APPLICATIONS

This application claims priority as a continuation-in-part from U.S. patent application Ser. No. 16/256,089, filed on Jan. 24, 2019, entitled “AUTOMATED ONTOLOGY SYSTEM,” the entire contents of which are hereby incorporated by reference.

### BACKGROUND

It has long been an axiom of computer science that “humans use inductive reasoning, but computers use deductive reasoning.” Numerous computer science courses begin with a similar axiom and an explanation of the two types of reasoning as a way of coaching students to begin “thinking like a programmer,” with the expectation that a good command of deductive reasoning is necessary to perform any programming at all.

To provide background, deductive reasoning is a reasoning process that works from general axioms to more specific, logically certain conclusions. In deductive reasoning, a general rule is developed which holds over the entirety of a closed domain of discourse, and subsequent general rules are applied in order to narrow the range under consideration, allowing a conclusion to be reached reductively once only the conclusion is left as an option. A simple, commonly used example of deductive reasoning is “All men are mortal [a first premise], Socrates is a man [a second premise], therefore Socrates is mortal [the conclusion].” In such an example, the first premise requires all objects classified as “men” to have the attribute “mortal,” the second premise requires Socrates to be classified as a member of the set “men,” and as such the conclusion can be drawn that Socrates has the attribute “mortal” as a necessary aspect of his membership in the set “men.”

Three major reasoning processes may be applied as part of “deductive reasoning,” these being modus ponens, modus tollens, and syllogism. Modus ponens is the process described in the example described above, regarding Socrates; a first premise is provided, “If P, then Q,” and a second premise is provided, establishing “P.” Following the first premise and combining it with the second premise, it may thereby be established that, since P is true, and If P, then Q, then Q is true. Modus tollens is the contrapositive of this. “If P, then Q” is still established as a first initial premise, but as a second premise, it is then established that Q is not the case, the “negation of the consequent,” represented as “−Q.” Since, as per the first premise, Q must follow from P if P exists, and since, as per the second premise, Q is not present, then the natural consequence of P existing—Q also existing—has not been observed, and therefore P cannot exist. Syllogism is used to bridge premises. For example, “if P, then Q” can be established as a first initial premise, and “if Q, then R” can be established as a second initial premise, meaning that it can be reasoned that “if P, then R.” Since P existing would have to mean Q existing, and since Q existing would have to mean R existing, the two premises can be combined in this manner.

There are certain limitations to the process of deductive reasoning, which can limit its application. To start, a distinction must be drawn between the “validity” and the “soundness” of any argument made through deductive reasoning. An argument can be said to be “valid” when, assuming that the premises are true, the conclusion logically follows. “Valid” arguments can still be factually incorrect. For example, it may be said that “if P, then Q,” and “P” may be observed to exist, but “if P, then Q” may not be true as a universal rule, and may only be true some proportion of the time. Therefore, in a particular case, “if P, then Q; P; then Q” may be a valid argument, following logically from its premises, but may still be wrong, since it is based on faulty information or information that cannot be properly universalized. “Sound” arguments, on the other hand, are those which are valid, and which have true premises. Computers, in particular, have trouble distinguishing between the two, and have little ability to evaluate soundness; for example, a premise that is true 99% of the time can cause significant amounts of difficulty.

Deductive reasoning also has certain limitations when higher-order logic is involved. Many classic illustrations of deductive reasoning make use of propositional calculus or “zeroth-order logic,” which deals with propositions and argument flow. (Reasoning such as “if P, then Q; P is observed, therefore Q is true” illustrates such propositional logic.) First-order logic additionally contemplates that each statement may be broken down into a subject represented by a variable (x) and a predicate modifying or defining the properties of the subject (P), such that the entire sentence may be represented as P(x). This may be used in order to relate statements that could not be related under propositional calculus or “zeroth-order logic.” For example, a first statement, P, could be “Socrates is a man,” and a second statement, Q, could be “Plato is a man.” Under propositional logic, there would be no way to relate the two statements, even though they have the same premise. Under first-order logic, the two statements would be represented as the subject-predicate pairs P(x) and P(y). Logical operations can also be differentiated as universal or existential; for example, when a first predicate (“is a man”) is encompassed within a second predicate (“is a mortal”), we can construct the statement ∀x: Ax→Fx (“for all x, if x is a man, x is mortal”), and alternatively can construct the statement ∃x: Fx→Ax (“for some x, if x is a mortal, x is a man”). Certain additional complications are also introduced; for example, the incompleteness theorem, proven in 1930, demonstrates that there are statements in the first-order logic form that under certain conditions cannot be proven either true or false, meaning that there must be some alternative way of resolving such statements.

Further higher-order logic makes use of additional structures. For example, while first-order logic quantifies variables that range over individuals, second-order logic also quantifies over sets, and third-order logic also quantifies over sets of sets (and so forth). A second-order logical structure will include individual variables, which similarly to first-order logic are often denoted in lower case (e.g. x, y, z . . . ), but will also include property or relational variables, which are often denoted by upper-case letters (e.g. X, Y, Z . . . ), with function variables likewise being in upper-case letters (generally separated in the alphabet from the other relational variables, e.g. A, B, C . . . or F, G, H . . . ). (In some cases, a separate classification for function variables is omitted, with function variables being folded into “relations” as merely a special case thereof.) In this manner, second-order logic does not just quantify the objects but also the functions and predicates. Individual variables may be seen essentially as set members of the relational variables or function variables; for example, x∈A, or “x is an element of A,” may be short for A(x). Third-order logic then likewise includes variables denoting properties of properties, and so forth for fourth, fifth, and higher orders of logic.

Often, such reasoning can be simplified into first-order logic through the use of set theory. A second-order expression can be expressed as “Every set . . . ” and a third-order expression can be expressed as “Every set of sets . . . ,” and so on and so forth. Deductive reasoning processes can likewise be applied to second-order logic and higher orders of logic, most easily through such substitutions; for example, one such deductive system can be a standard deductive system for first-order logic which is augmented with second-order substitution rules for second-order terms. (As noted, however, no deductive system contemplated for use in a second-order logical system or higher-order logical system can be complete.)

Inductive reasoning works in an opposite manner to deductive reasoning, moving from specific observations to broader generalizations and theories. In inductive reasoning, a conclusion may be reached by generalizing or extrapolating from specific cases to general rules which govern all such cases.

Inductive reasoning can be best described by contrasting it with deductive reasoning. In contrast to deductive reasoning, which derives conclusion b from premise a only where b is the formal logical consequence of a, inductive reasoning is fuzzier, and can allow the inferring of b from a, where b does not follow necessarily from a. This means that conclusions drawn from inductive reasoning are based on some degree of guesswork as to what rule actually covers all potential cases, and such conclusions can often be wrong if the observed cases are not representative of the set of all potential cases. For example, if it can be reasoned that, if P is true, then consequently Q, R, and S are each true, deductive reasoning may, if P is established as true, likewise be able to establish Q, R, and S as true. An example of inductive reasoning, however, might have an observer establishing that, upon finding that Q, R, and S are simultaneously true (when Q, R, and S are all relatively independent and such a pattern is rare outside of P being true), P is likely to be true with some degree of probability.

A practical example of inductive reasoning might be as follows. If a number of swans are observed and all observed swans are white, a conclusion may be drawn (and associated with some degree of probability or certainty) that all swans are white. The conclusion is justifiable, but the truth of the conclusion is not guaranteed. (As some swans are black, it is actually wrong in this case.) As such, instead of being able to draw the conclusion of “All of the swans we have seen are white, therefore we know that all swans are white,” this conclusion must be associated with an epistemic expectation, i.e. “we expect that all swans are white (based on some level of certainty).”

A further reasoning method, abductive reasoning, is also sometimes necessary. Abductive reasoning is a process principally used in formulating hypotheses, and allows inferring a as an explanation of the cause of b, even without clear evidence establishing that “if a, then b” is a universal principle or premise of the sort that could be applied to deductive reasoning. Logically, abductive reasoning is equivalent to the fallacy of affirming the consequent, or “post hoc ergo proper hoc,” because of the possibility of multiple different explanations for b, meaning that a may play a comparatively smaller part than assumed or may even be associated with b as pure coincidence.

For example, given a set of observations O, a theory T, and a potential explanation E, for E to be abductively reasoned as an explanation for O, then, overall, the system should satisfy two conditions. First, it must be established in some manner that O follows from E and T. Second, it must be established that E is consistent with T. Some “best explanation” can then be selected from multiple Es if multiple Es fit the requirements; often, this requires some sort of subjective evaluation of the simplicity of a given explanation, the prior probability of similar explanations, or the explanatory power of the explanation.

For example, if a white feather is found on the ground, it may be abduced that a swan was present and that the presence of the feather was due to the presence of the swan, because the presence of the swan (losing a feather) would account for the presence of the feather. This would provide a hypothesis explaining the observation. Plenty of alternative explanations may exist, however, which may be seen as less likely; for example, a person may have passed by with a feathered costume or feathered clothing (such as a feathered dress), or a person may have camped there with a down sleeping bag that lost some of its contents (from a rip or tear), or the feather may be from another bird entirely. It may also be conceivable that the feather blew to the location where it was observed from elsewhere. The potential explanations can be evaluated based on their simplicity; for example, if it is known that swans nest in the area and swans can be seen at a distance, the swan explanation may be the simplest, whereas if the feather is found within a ballroom, the swan explanation may require a further explanation of how the swan came to be in the ballroom, why the swan was not removed from the building before reaching the ballroom, and so forth, and a simpler explanation may instead be that the feather fell off of a costume. The potential explanations can also be evaluated based on the prior probability of such explanations being accurate; for example, if a large number of white feathers are observed to be dropped by swans in the area, any newly observed white feather may be likely to have come directly from a swan, even if the feather was not seen falling. However, if a large number of feathers actually come from campers with downy jackets or sleeping bags, and swans avoid the area because of the human presence, then it may be more probable that the feather was left by a camper. Finally, the potential explanations can be evaluated based on the explanatory power of the explanation to encompass other observations as well; for example, if a feather is found having glue on it, an explanation that the feather came from a costume may have more explanatory power (explaining the feather observation and the glue observation) even if swans are likely to nest in the area and people in costume are rarer. Likewise, if a feather is found next to a matted area of grass and a torn scrap of polyester fabric found on a rock, an explanation of the feather having been left by a camper may have much more explanatory power, as it may explain the presence of the matted grass (the camper pitched a tent there or unrolled a sleeping bag there) as well as the presence of the fabric together with the feather (the camper ripped their sleeping bag or jacket on the rock, and a feather came out).

As such, despite many such alternative explanations of a phenomenon, or a collection of phenomena that are observed, a single explanation (or a few explanations) will generally be abduced through this process, as a working hypothesis. Some possibilities can thus be disregarded. (This is suspected to have been an important evolutionary skill for humans, in that it may allow unfamiliar surroundings or unfamiliar situations to be navigated. However, attempts to implement such reasoning with computer systems have been fairly weak, finding a limited level of success in diagnostic expert systems and other such systems.)

As touched on briefly above, deductive reasoning has been much more successfully implemented on computers, and a variety of systems have been implemented for performing deductive analysis tasks on computers. Computers have been used to discover features and patterns in large data sets, to find correlated phrases in text, to analyze image data, and to prove logical theorems by deductive reasoning. This has allowed for large leaps in capability in certain areas, such as image recognition, as data have ballooned in availability. Computers can identify particular patterns in extensive image data sets (such as ImageNet's database of approximately 14 million images, many with manually added identifiers and descriptors to improve reasoning) and identify features common to many or most of the images related to a certain topic. This allows for computers to greatly assist with the inductive reasoning processes that may be performed by a human operator or programmer. However, the ability to actually invent or understand ideas has remained uniquely human, or at least biological, to the point where even non-human animals are looked at as a more likely source of such origination than computers are. (To date, the United States has had at least one court case regarding the potential intellectual property rights of a non-human animal, but AI-derived IP has been a pure hypothetical.)

A simple example can be considered to demonstrate the existing limitations of computers with respect to automated reasoning. It would be possible, in principle, to present a machine learning program with examples of triangles. A computer program set up to test the relative lengths of the three sides may be able to validate an approximation of the Pythagorean Theorem within some error limit, if presented with enough examples of right triangles, obtuse triangles, and acute triangles. However, the empirical discovery of this approximation could never replace the exact formulation of the Pythagorean Theorem itself, which depends on a foundation of prior geometrical understanding, and which serves as a theoretical underpinning for many diverse areas of mathematics and other sciences that would be difficult to understand without it.

An ongoing trend in the field of artificial intelligence has been its evolution away from the oversimplified apparatus of rule-based systems toward systems not based on centralized control or processing. The large increase in the number of layers in newer convolutional neural network (CNN) systems has made possible the concept of “deep learning,” which has dramatically improved the ability to discriminate patterns in imagery, text, and other data by using these highly structured CNNs to identify patterns based on training of the CNN program.

However, detecting a pattern or feature in data is not the same as the understanding the pattern, interpreting the discovery in the context of other information or knowledge, or making theoretical predictions that synthesize broad areas of learning. Even despite advances in pattern detection, because of the limitations of these techniques, there are at present no machine learning systems that can compete with humans at all in areas like comprehending image or text data. The most effective systems, at present, are NLP systems used to try to gauge the sentiment or gist expressed by a text document from the statistical analysis of co-occurrences of words and phrases. Based on this analysis, a sentiment or summary (such as a two-line summary of a news article for a news ticker, or some similar result) may be produced with some accuracy, but only may be discoverable based on statistical data characterizing a large set of such news articles and consistency in the word choice and sentence structure of such articles. No significant amount of anything that could be called understanding of intentions, concepts, or purposes of statements in any media, from text to images to video, has been achieved.

For example, in video analysis, detection of movement is relatively simple, and identification of objects based on features often succeeds, but it is difficult for a computer to construct a narrative based on object recognition and a priori knowledge of objects in a scene. Even if the identity of each object and the positions of each object are “known” throughout the duration of the video, the computer has little to no ability to identify what is actually happening in the video without the same sorts of techniques used in image recognition in the first place. (For example, a machine learning-based reasoning system may be able to analyze a video clip of a person throwing a ball on the basis of still images in the video clip, and may be able to identify individual frames on the basis of their similarity to other images. With additional processing, it may be able to identify that the video clip includes “man holding ball,” “man AND ball,” “man” (with the ball then being out of the frame), but may not be able to chain all of the aspects of the video clip into any sort of narrative. Similarly, natural language processing (NLP) can extract patterns in word groups in vast amounts of text data, but that is different from reading and comprehending the text. Machine learning systems would readily fail the Turing Test, which requires computers to match human intelligence to a degree that makes them indistinguishable from humans.

Automated theorem-proving programs, inference engines, and expert systems have been applied to automated reasoning problems with mixed success. By way of background, automated theorem-proving programs or algorithms, “ATPs” for short, prove mathematical theorems using computer programs. In such programs, knowledge is codified as “theorems,” assumptions and postulates are codified as “axioms,” and hypotheses are tested for truth or falseness by a process known as “paramodulation,” which involves testing the consistency of the hypothesis with the prior knowledge contained in the stored axioms. Examples of success include hardware verification, proof verification, demonstration of the correctness of computer programs, and model checking. Automated theorem proving algorithms have been applied in physics, geometry, and computer vision, among other areas. Automated theorem proving algorithms have been used as proof assistants in checking the correctness of mathematical proofs, and in some cases, have discovered proofs for unsolved conjectures. Inference engines generalize the capabilities of expert systems beyond first-order and deductive logic, and may include techniques such as “forward chaining” (deductive reasoning to a conclusion, or identification within a knowledge base, from given premises) and “backward chaining” (use of a search algorithm to test a hypothesis).

However, in general, automated theorem proving programs need operator assistance and human control to operate successfully, due to factors such as a lack of flexibility. (For example, almost all ATP programs require a highly formatted input structure that is not only not necessarily compatible with most types of inputs but is not necessarily compatible with many types of data, as many types of data cannot be tested for consistency with the prior knowledge contained in the stored axioms by existing ATP software.) A basic strategy for using such systems is to apply inference rules to demonstrate that a conjecture is a logical conclusion of given propositions. The process may formalize logical systems in such a manner as to apply constructs from propositional calculus and may use first-order logic structured as sentences containing assertions with variables. One example might be the expression “Jupiter is a planet,” which might be expressed using the logical statement “planet(x). x=Jupiter.”

As mentioned earlier, another such approach to proof checking systems or other similar systems is paramodulation. Paramodulation is a method of theorem proving in which rules of inference operate on two clauses to yield a third clause. In the simplest cases, it can be a trivial statement of the transitive property, where appropriate variables are substituted for other variables; for example, if a=b and b=c, then a=c. However, the process can be used to map complex hierarchical relationships and is not confined to obvious equalities. Properties of set theory and Boolean logic can be expressed with this formalism.

No systems have yet been created that go beyond proof checking and statistical processing of language and imagery. Most importantly, no systems have been able to, by themselves, generate interesting conjectures, in a manner that could match or exceed human capabilities. Some algorithms exist that can solve problem sets created for theorem provers. Algorithms have been designed to propose interesting conjectures for solutions to riddles and puzzles, where “interesting” is defined by values such as the degree to which a particular hypothesis is “surprising,” the degree to which it is “novel,” or the degree to which it shows “complexity.” (It may be noted that this is somewhat contrary to typical principles of abductive reasoning and hypothesis drafting, which, as discussed above, emphasize simplicity and consistency. A major reason for this is that, because such systems are in their infancy, they cannot easily supplant processes that humans are good at, but can potentially supplement such systems by providing unusual reasoning that humans may not necessarily have duplicated, but which may sometimes have value.) The basic idea is to generate hypotheses from existing rules in an “ontology,” defined as a set of concepts and categories in a subject area or domain that shows their properties and the relations between them. Hypothesis generation can be accomplished as a permutation of existing relationships, or a search through a topological graph structure such as a tree. The ontology may function as an expert system, taxonomy, or knowledge base.

Some automation has been achieved along these lines in generating hypotheses for autonomous experimentation. For example, by using comprehensive feedback loops, it has been possible to improve the rate for serial carbon nanotube experiments by a hundred-fold. The methodology makes it possible to develop new or more accurate hypotheses, explore a large parameter space of possible experiments, generate multivariate questions, and optimize the parameters that may be applied to lab experiments. The autonomous method plans, generates, and evaluates its own experiments. However, the application of similar types of techniques to other knowledge domains has thus far been limited, because of the need to tie the method to a rule-based format that can be optimized using these comprehensive feedback loops.

### SUMMARY

A method of automated generation of conjectures may be contemplated herein, together with various exemplary embodiments suited for one or more specific applications of such a method. For example, according to some exemplary embodiments, such a method may be employed for experimental purposes, and may for example be used to automatically generate hypotheses, in such a manner as to allow those hypotheses to be automatically tested and validated, if desired. In other exemplary embodiments, such a method may be used to allow a system to respond to new scenarios and to make conjectures in non-laboratory contexts. For example, according to an exemplary embodiment, it may be contemplated to have a system that reads text, listens to spoken language, or views images or video, and then formulates a response or a reply to a user based on comprehension of the input; or generates some form of classification for the text, spoken language, or video; or initiates mechanical movement in a robotic system, or some other mechanical sequence of actions.

In a first exemplary embodiment of a method of generating conjectures, it may be contemplated that some existing systems allow for some limited generation of conjectures, such as interesting conjectures, provided that such conjectures are represented in a rule-based format. As such, according to an exemplary embodiment, it may be contemplated to use a method such as described herein to generate rule-based formats from natural language text.

According to an exemplary embodiment, an NLP program, such as the Stanford NLP program, may be provided and may be configured so as to parse an input sentence into a desired structure. Such NLP programs, like the Stanford NLP and analogues, may function in a form such that, or may be configurable to a form such that, they may be used to construct sentence diagrams from input text provided in English or other languages. For example, in an exemplary embodiment, a sentence may be parsed into a tree-based structure in a manner that defines the relationships between each entity in the sentence.

The output of the NLP program may then be used to generate functional relationships between the entities identified in the sentence, which may then be used to generate the desired rule-based structure. This may then be processed by automated theorem-proving software or an inference engine or expert system, in such a manner as to allow the automated theorem-proving software to conduct operations. In various exemplary embodiments, the present method of automated generation of conjectures may solve the problems of accomplishing the translation of the text into coherent rules and then searching the rule space for possible relationships or conjectures that can be used in order to operate the automated theorem-proving software.

According to an exemplary embodiment of a method, several stages may be understood. In a first step, the method may begin with formation of a knowledge domain through knowledge base construction or ontological engineering. In a second step, the method may perform ingestion of information from open sources. In a third step, the method may perform transformation of the ingested information into theorems or other rule-based structures. In a fourth step, the method may perform conjecture generation, and in a fifth step may perform hypothesis testing. Each such step may be discussed in turn.

According to an exemplary embodiment, the method may make use of an automated theorem prover or inference engine to implement first-order or higher-order logic in a rule-based system such as PROLOG. Other components of the system may search for exceptions to hypotheses or theorems, for example, cases in which theorems cannot be proven true, in order to prove the theorem untrue. In certain exemplary embodiments, systems such as the systems selected above may be chosen for their simplicity and ease of use, or their ability to easily handle inputs provided in the form of text files; in other exemplary embodiments, other theorem proving programs, inference engines, rule-based systems, or expert systems may be chosen and may be used in addition to the above or instead of the above, such as may be desired, based on any criteria that may be desired, such as the ability to input or output data in a particular format, processing efficiency, or any other such criteria.

In certain exemplary embodiments, a theorem prover may be equipped to make use of higher-level orders of logic than first-order logic. Higher-order logic in general is sometimes better suited for expressing logical concepts than first-order logic, and can make it possible to address a wider range of problems. It can express some concepts such as countability or finiteness that are not able to be characterized in first-order logic. Automated theorem proving for higher-order logic most typically makes use of a first-order theorem prover in order to reduce the proof burden to the maximum extent possible, generally making use of set theory as discussed above to “translate” the higher-order expressions into first-order logic. For example, under one such configuration, nested application functions may be applied, so that the higher-order term f(X(a)) is translated into the system as the first order terms app(f, app(X, a)), such that the system executes first the term app(X, a) and then executes the remaining terms. In such a manner, if a higher-order function f consistently appears in the input program with a set of at least n arguments, then the function may be translated to a first-order function having an arity of n. (One example of such a configuration is the “Sledgehammer” tactic executed by the ISABELLE solver, which translates a current goal to first-order logic and then calls a number of first-order solvers in parallel on the translation. Another example is the LEO-III solver, which likewise relies on primitive substitution.) However, this can be inefficient, and some efforts to extend theorem-prover software so that it can execute higher-order logical expressions natively have been made. Higher-order programming can be used to apply concepts of higher-order logic in programming. It uses features such as predicate variables derived from higher-order logic, and is implemented in some languages, such as several extensions of Prolog, which are contemplated for certain exemplary embodiments of a system such as described herein. Both first-order logic-based automated theorem provers and automated theorem provers equipped to handle higher-order logic are contemplated.

In an exemplary embodiment of a system, a theorem prover or inference engine may be used in order to perform the following steps. In a first step, from a list of incomplete rules stored in an acceptable format for the automated theorem prover (ATP) or inference engine (which may need to be preceded by a “step 0” in which data are appropriately formatted), various permutations of existing rules may be formed by the software. Each permutation of a rule may represent a conjecture. The permutations may be generated from existing theorems (rules) in the database. This may make it possible to constrain the conjectures to a search space that spans a practical limit of reasonable assertions, by ensuring that the tested results have at least some similarity to an existing, previously tested result.

Once these permutations have been formulated, and placed in the correct format, each permutation may be tested in the theorem-proving software. For example, according to an exemplary embodiment in which the PROVER9 automated theorem prover software is used, the format for such software may be to write the hypothesis to be tested as a line by itself below the postulates. A formatting tool may be used, if desired, to generate text files corresponding to the theorems to be tested.

The program may then function to filter out the false and unproven conjectures, and retain the conjectures leading to valid proofs. The valid proofs may then be sorted according to particular criteria in order to identify which of the proofs are most likely to be of interest. (One such method of sorting the proofs according to an anticipated level of potential interest is, for example, the tree complexity calculation offered by the PROVER9 software. Another method of sorting conjectures and proofs is to use the topological graph structure described later in this application to give priority to objects in the knowledge base with greater value to the problem at hand, as determined by some metric such as shortest path distance, neighborhood features, adjacency, and so forth.)

An example employment of such software may be provided below, in the Detailed Description, in order to demonstrate how the software may be employed as a component of the presently described method. Specifically, such software may be used in order to generate a family tree for the characters of Greek mythology, based on the interrelationships that each character has with one another.

The generation of conjectures can be applied iteratively; once theorems are proven, they can be added to the ontology. In this way, the machine learning system is able to develop, validate, and test a world view that encompasses a universe of relationships.

Likewise, the generation of conjectures can handle other sorts of input data, including input data that has fuzzy logic and uncertainty inherently incorporated into it. In such an example, hypotheses that contain quantifier concepts such as “some,” “all,” or “none” may be generated; in other exemplary embodiments, a system may attempt to estimate probabilities or retrieve probability data, if such is desired.

In some exemplary embodiments, such a methodology may be applied to text-based information such as is described herein, but in other exemplary embodiments, such methodology may be applied to encoding any other sort of set-theoretical relationship, such as computer vision, network topology, geometrical theorem proving, or any other such application such as may be desired. Semantic computer vision techniques such as Bag-of-Words, word embedding, and word vector processing, which identify image feature information and store the detections in formats consistent with semantic and text processing, may be used to construct input to the theorem prover or inference engine.

Now that an exemplary embodiment of software that may be used to perform aspects of the present method has been described, each of the five steps discussed above may be further described.

As noted, in a first step, the method may begin with formation of a knowledge domain through ontological engineering. To provide some examples of how this might work, it may be contemplated that the English dictionary may function as a potentially complete ontology for many practical purposes. (In certain exemplary embodiments, various permutations of an English dictionary, or subsets thereof, may be envisioned as making up this ontology, and as such the use of terminology like “a dictionary” may not necessarily be limited to a single dictionary or database source. For example, one example ontology could be derived from a digitized version of a standard English dictionary, such as the MERRIAM-WEBSTER dictionary or OXFORD ENGLISH DICTIONARY. In another exemplary embodiment, a lexical database of English such as WORDNET or CONCEPTNET may serve as a source of an ontology, instead of or in addition to the use of the standard dictionary. In certain exemplary embodiments, multiple dictionaries or databases may be combined. Various forms of combining sources as part of a process of generating a combined dictionary or overall ontology can also be contemplated; for example, a “dictionary” can be a combination of dictionaries and databases in a manner that optionally incorporates reliability scoring or ranking to distinguish certain dictionaries or databases from one another or direct the ontology toward the results provided by more reliable sources. For example, it might be desired to make use of a combined dictionary in which the OXFORD ENGLISH DICTIONARY is used as a baseline, potentially less reliable sources like DICTIONARY.COM or WIKTIONARY are used to fill in gaps in circumstances where the OXFORD ENGLISH DICTIONARY does not provide a definition, and even less reliable sources like URBANDICTIONARY are used to fill in additional gaps in circumstances where none of the preceding sources provide a definition.) Ontologies may be in a number of different formats, for example, JSON (JavaScript Object Notation), AMR (Abstract Meaning Representation), YAML (YAML Ain′t Markup Language), or XML (Extensible Markup Language), or in some other unspecified format for recording attributes of entities in the knowledge base.

All English words may, in this case, be defined by other English words (including, for example, words of foreign origin that have been absorbed into English, like entrepreneur, resume, and the like), or may have their meanings inferable based on similar words (for words with similar roots and so forth). As such, a standard dictionary may be transformable into a complete ontology, using automated methods such as outlined above, or by meticulous human translators. The English language, and spoken languages in general, are challenging because they are rich in nuance; certain words, and especially certain phrases, may have different meanings based on the context in which they are used. However, it may be possible to generate rich ontologies for first-order logic (FOL) and higher-order logic (HOL) from a limited vocabulary.

As an example, certain dictionary definitions may be translated into theorem axioms or assumptions to show how this process might be performed by an exemplary embodiment of the system. For example, as defined in a standard dictionary—in this case, Webster's Collegiate Dictionary, 1948—a “mother” may be defined as “a female parent, esp. one of the human race; specif. [often cap.], one's own mother.” Parsing this information on a system such as is presently defined, “mother” can be defined as a “female parent,” and if desired additional nuance may be added to implement modal logic and operators, either based on probability (a “mother” may have a high probability of being a female parent, and a slightly lower probability of being a human female parent, with a low probability of referring to a human female parent of the speaker, which may be adjusted to a higher probability if the word is capitalized) or based on “suggestion” associations that may be evaluated at a later stage of the processing, if desired. As such, although it is noted that there are several alternative definitions (and methods of processing alternative definitions are given below), for the immediate purpose of example, the definition given above will suffice.

As noted, the definition above may imply, at the most basic level, a “female parent.” This may be represented as the first-order logic statement “-parent(x)|-female(x)|mother(x).” That is, stated in English, an object can be not a parent (“-parent(x)”), not a female (“-female(x)”), or can be both. If the object is a parent and a female, then it will be defined as a “mother” (“mother(x)”). Going through each character in detail, if something (“x”) is not (“-”) a parent (“parent(x)”), then the statement is true. Alternatively/“or” (“|”), if that something (“x”) is not (“-”) a female (“female(x)”), then the statement is also true. As one last alternative (“|”), if neither of the preceding statements are true (NOT “-parent(x)” AND NOT “-female(x)”) then the last statement must be true, and the object (“x”) must be a mother (“mother(x)”).

The definition of “female” in that same dictionary is “a woman or girl; a female human being; also, a female animal.” Therefore, representing this definition in terms of first-order logic, the first-order logic statements “-girl(x)|female(x)” (that is, if something is a girl, then it is female; therefore, it must either not be a girl (“-girl(x)”) or must be a girl and therefore must be female (“female(x)”)), “-woman(x)|female(x)” (that is, if something is a woman, then it is female; therefore, it must either not be a woman (“-woman(x)”) or must be a woman and therefore must be female (“female(x)”)), “-female(x)|animal(x)” (that is, by the rest of the definition, if something is female, it is an animal, such that it has to be at least one of not female (“-female(x)”) or an animal (“animal(x)”)), and “-female(x)|human(x)” (that is, if something is female, then it is a human, such that, according to this definition, it has to be at least one of not female (“-female(x)”) or a human (“human(x)”)) would be used. In some exemplary embodiments, some of these definitions may be expected to be nested; for example, a “human” may inherently be an “animal,” and “-female(x)|human(x),” if adopted as the definition, may inherently imply “-female(x)|animal(x).” In other exemplary embodiments, each statement may be separate from one another and assigned a separate probability; for example, “-female(x)|animal(x)” may be highly probable (with a potential exception being, for example, a “female” end of an electrical plug) and “-female(x)|human(x)” may be somewhat less probable (and again necessarily imply “-female(x)|animal(x)”).

The definition of “girl” is “female child.” Therefore, this may result in the first-order logic statement “-female(x)|-child(x)|girl(x),” based on the reasoning provided above; if something is female, and it is a child, then it is a girl. (In some exemplary embodiments, it may instead be preferred to have a statement such as “-female(x)|-human(x)|-child(x)|girl(x),” depending on how terms like “female” are defined, or what their probabilities are. In some exemplary embodiments, such definitions may be gleaned from combining the results of different dictionaries in order to generate the most consistent possible definitions, or in order to assign probabilities based on how often particular concepts are phrased in each dictionary. For example, if all dictionaries define a “girl” as at least a “female child,” but some specify that a “girl” is a “human female child,” the first-order logic statement “-female(x)|-child(x)|girl(x)” may be generated, with a lesser probability associated with “-human(x).”

Each of these objects has been written as a function that has one variable. However, the definition of “parent” is “one who begets or brings forth offspring; a father or a mother.” Hence, the following FOL definition can be constructed: “-father (x, offspring)|parent(x, offspring),” and “-mother (x, offspring)|parent(x, offspring),” whereby if something is a father (with offspring) then it is a parent (of that same offspring), and likewise if something is a mother. The same exercise can be carried out for the other English words used in the previous section, such that any additional variables are added as applicable. (For example, a “child” may necessarily have a “parent.”)

As touched on to some extent above, certain words may have alternative definitions, which may parallel one another (for example, a “female” referring to an animal or to a human, which is necessarily an animal) or which may be exclusive with one another (for example, a “female” referring to one part of an electrical plug and having nothing to do with animals or humans whatsoever). It may even be understood to have the same words function as nouns, verbs, or other parts of speech. One other example of an alternative definition, for “father,” is “a priest.” As such, according to an exemplary embodiment, two different alternative definitions may be constructed, for example, “-parent (x, offspring)|-male(x)|father(x, offspring),” and “-priest(x)|father(x).” In some exemplary embodiments, words may be assigned particular probabilities based on the frequency of use or the context of use; for example, just as was the case with “mother” versus “Mother,” the capitalization of the word may affect which usage is more likely. (For example, “Father” used as a proper noun may be most likely to refer to the speaker's parent, while “Father X” may be most likely to refer to a priest.)

According to an exemplary embodiment, in order to process such words with ambiguous references, two or more parallel ontologies may be tested for provability. This could be accomplished using the same search space generation techniques for conjecture generation that were described in the previous section. (For example, in an exemplary embodiment, probabilistic reasoning may then be applied to resolve which of the ontologies is more likely to be accurate, with the highest match being taken as the accepted ontology.)

Such a system may be consistent with, and may be able to draw from or even export to, certain systems of classification hierarchy that may be used in Web documents. For example, according to an exemplary embodiment, the system may be adapted to import information from, or export information to, formats such as the Ontology Web Language (OWL) or the Resource Description Framework (RDF), each of which may function as such a system of classification hierarchy. For reference, the OWL and RDF systems, and other such systems, are Internet taxonomy systems that allow development of ontologies or related taxonomy classification schemes that relate objects to other objects. Other such systems of classification hierarchy may also exist and may be made use of in other exemplary embodiments, such as may be desired.

To describe some of the above example systems in more detail, it may be noted that, in the OWL languages and variants thereof, semantic relationships may be encoded into the languages. RDF, on the other hand, may use “triples” that include a subject, predicate, and object strung together (“subject-predicate-object”) which may be easily expressed in FOL format. For automated translation into FOL, according to an exemplary embodiment, the ontologies may be derived from the implicit logic built into the sentence trees, and may then be worked into the existing ontology stored as a database of theorems. Other more complex ontology languages which allow more complex expressions, higher arity, and greater syntactic and logical expressiveness may also be used in the exemplary embodiment.

Moving forward, as noted, in a second step of an exemplary embodiment of the present method, the method may perform ingestion of information from open sources. According to an exemplary embodiment, this may allow for generation of axioms for a theorem prover through the use of web searches (either of particular areas of content or unrestricted web searches, such as may be desired) or ingestion of documents or other materials, which may be written in plain text such as may be desired.

According to an exemplary embodiment, the present system may be provided with a parser which may be configured to translate natural language into FOL and HOL statements. According to an exemplary embodiment, in order to implement such functionality, an approach to text processing may be taken which differs from standard Natural Language Processing statistical approaches. For example, in order to apply inference engine logic, it may be contemplated to syntactically and semantically parse words in text similarly to subroutines or function calls in a computer code compiler, to generate input into a NLP-based compiler that generates logical statements or rules for the ontology.

Many current NLP algorithms are configured to be, or to use, statistical searches that measure the frequency of use of selected words and their co-occurrence with other words. This allows certain words to be related to certain other words, allowing certain functionality such as auto-typing suggestions to be implemented. However, though these features are interesting, they do not actually provide any meaning of the text; a first word may be followed most commonly by a second word, which may be suggested to a user as an automated suggestion or used for whatever other purpose may be appropriate, and then the second word may be followed most commonly by a third word, which may be handled in the same way (generally based on the second word, and, to a lesser extent, the first word and the use of each word together). This application of machine learning is inherently approximate and statistical; it is incapable of understanding text as humans understand it; it does not help build a complete ontology, and can attribute no actual meaning to concepts other than co-occurrence and frequency. For example, such a system may be easily able to predict that, when someone types “Happy” followed by “Birthday,” they are likely to follow that up with “To You.” However, the system cannot divine any meaning from this on its own, and manual suggestions must typically be added if any particular functionality is desired to be paired with such a system. (For example, if it is desired to pair such a statement with certain options to provide an image, emoji, or other greeting, such greetings must generally be tagged with appropriate use terminology.)

NLP-based grammar parsing technology is more mature, and has been used for translation of natural language using grammatical rules for over a decade. NLP has also been combined with theorem-proving software in the question answering system LOGANSWER; natural language queries are transformed into formatted query terms and processed by FOL against an extensive knowledge base. Some forays into automated ontology generation and domain knowledge acquisition have been made using natural language text; for example, robots intended to generate a movement area ontology have been able to incorporate some level of natural language processing in order to more properly define an area in which the robot may move or operate. Likewise, some attempts have been made at generating programs through natural language.

However, as yet unsolved is the concept of processing the NLP tree structure of sentences by a natural language parser that generates FOL statements, analogous to the parsing of programming statements by a compiler, particularly based on knowledge gleaned from directed searching through external sources rather than through detailed dictionaries fed as input into the NLP system. Unlike standard programming languages, which have a limited number of context-sensitive features, natural languages have many context-sensitive features; as such, it is significantly more difficult to provide a system that can automatically generate coherent sentences than it is to provide a system that can automatically generate simple program statements. Multiple tree structures and graph representations may be constructed for many sentences in natural languages such as English, and meaning can be ambiguous even to human listeners.

According to some exemplary embodiments, however, it may be contemplated to resolve ambiguities in word meaning or sentence structure by optimizing a finite search space, in which multiple interpretations of sentences into FOL and HOL are evaluated for the highest consistency with prior assumptions. For example, based on the example used previously regarding a “Father” being a parental figure versus a priest, it may be contemplated to determine, with the system, whether previous words and phrases used in the text related more closely to religious institutions, implying that this was the topic of conversation and that an ambiguous use of “Father” referred to a priest, or whether previous words and phrases used in the text related more closely to family institutions, which might imply in some cases that an ambiguous use of “Father” referred to a parental figure. Alternatively, the system may look for other directly related terms or similarly-structured sentences, or may otherwise evaluate sentences for the highest consistency with prior assumptions. Such a system may be contemplated to use multiple approaches, if desired; for example, multiple approaches may be sampled in order to reduce the effect of any one approach being fooled, or a different approach may be tried in turn if the system cannot resolve the ambiguity with a first approach. (For example, in one exemplary embodiment, when evaluating a sentence for the highest consistency with prior assumptions, a “topics approach” may be attempted. However, if the usage of the word is still irreconcilably ambiguous—for example, one could contemplate having a bride or groom give a wedding toast such as “Father, I want to thank you for being with us today . . . ” that could be entirely consistent with either interpretation—the system may determine which usage has the highest consistency with prior assumptions based on another method. For example, it may be determined that the groom had just toasted his mother with the same language, and as a result is probably talking about a parental figure.)

It is noted that, though an unconstrained search space may be NP-complete, the search space applied to this problem has inherent constraints that may make possible a global optimization within a finite error bound.

The concept of employing natural language processing for such purposes may be demonstrated by the following example, which, as discussed previously, may make use of the family tree of characters in Greek mythology. For the sentence, “Zeus is the father of Apollo,” the following output may be generated from a NLP system configured according to an exemplary embodiment of the present method: “<parse>(ROOT (S (NP (NNP Zeus)) (VP (VBZ is) (NP (NP (DT the) (NN father)) (PP (IN of) (NP (NNP Apollo))))) (. .)))</parse>.”

In the above string, the encoded data structure may represent a tree (which may specifically be shown in FIG. 7). Each left parenthesis implies a new child node, and each right parenthesis implies a traversal back up the tree. This may be based on the following identifiers: ROOT (the root of the subtree), S (the start of a particular sentence), NP (defining the next phrase as a noun phrase), NNP (defining the next phrase as a proper noun phrase), “Zeus” (the subject of the sentence), VP (defining the next phrase as a verb phrase), VBZ (defining the next phrase as a third-person singular present verb phrase), “is” (the verb phrase in question), NP(NP) (identifying that “the father” and “the father of Apollo” are nested noun phrases, DT (defining the next phrase as a determiner), “the” (the determiner in question), NN (defining the next phrase as a singular or mass noun), “father” (the singular noun), PP (defining the next phrase as a prepositional phrase), IN (defining the next phrase as a preposition or subordinating conjunction), “of” (the preposition in question), and “Apollo” (another proper noun). The period is also parsed and processed to signal the conclusion of the sentence. As English makes use of other punctuation marks to signal the conclusion of a sentence under other circumstances, it may be contemplated that other punctuation may be identified as well, and applied to establish context, for example, question marks indicating queries, commas indicating separate clauses, exclamation points as cues to possible emotional levels in statements, and so forth. Other variations may be contemplated for other languages, and may in some exemplary embodiments be used in order to identify a language to be interpreted in an initial stage; for example, the Thai language is notable for not using punctuation such as full stops, and as such the system may be configured to interpret blank spaces (or spaces over a certain length) as being equivalent to full stops in such a context. These linguistic identifiers may allow a computer to process the natural language text at a level that allows for meaningful interaction between the computer and the language text, by conclusively identifying the syntactic categories of each element in the sentence.

In the PROVER9 software or similar such software, such a string as provided above may be represented as a theorem, “father (Zeus, Apollo),” with the “father(x, offspring)” function discussed earlier using the parameters x=“Zeus” and offspring=“Apollo.” Likewise, the function “parent(x, offspring)” may share the same parameters and may likewise be satisfied.

Based on the above logic, it may be apparent that dictionary definitions, provided in English (or in any other language such as may be desired, or even in a combination of languages if such is desired) as complete sentences or otherwise in the form of natural text may be expressed in a first-order or higher-order logic format suitable for the building of an ontology for such data. In some exemplary embodiments, then, this information may then be used for the purpose of automated conjecture generation based on some applicable technique, such as one of the techniques provided herein. Any other complete sentences or other textual information, such as “a girl is a female child,” may be similarly ingested and processed into forms such as the above. That is, such sentences may be parsed into tree form such as (“<parse>(ROOT (S . . . ”) and may then be translated into FOL or HOL format.

In other exemplary embodiments, other processing programs besides PROVER9 may be used. For example, according to an exemplary embodiment, the PROVER9 structure shown above may be analogous to the triple table structure used in RYA, a Resource Description Framework used for developing metadata for the Internet. As such, RYA, or any other such framework or program, can be used alongside or instead of PROVER9. Such a decision may be based on any criteria, such as may be desired. For example, in certain exemplary embodiments in which greater flexibility is important, PROVER9 may be chosen over RYA or other programs that are less flexible; in other configurations in which the inputs and outputs of the system are more easily determined or controlled, or in which flexibility is otherwise less important, this may not be as significant a concern and another program or framework may be chosen. In PROVER9, for example, theorems of form F(x1, x2, x3, . . . xn) can be formed, such that even a very large number of words and phrases may be handled by the system when expressed in the form of a theorem. Since the pattern matching algorithm may not be restricted to triplets, allowing even sentences with highly complex syntactic structure to be translated into the required form. It may also be understood that the internal format of the theorems and their operators and parameters may be flexible and may vary across exemplary embodiments. Outputs may likewise be flexibly represented, so long as they are clear in scope; an axiom may be denoted f(x) or (f,x), or the parameters and functions may alternatively be stored in some other format in any potential embodiment.

The translation of English into FOL or HOL (or of another language into FOL or HOL, if desired) may involve syntactical rules and programming procedures similar to parsers and compilers. For example, some words in English may be treated as reserved words, such as “if,” “then,” “else,” “and,” “not,” “or,” etc., which may in some exemplary embodiments be parsed in a way that resembles structured program compilation. In order to implement this using NLP, according to some exemplary embodiments, the following processing steps may be taken. First, NLP software may be used to identify the parts of speech associated with all words, thereby making it possible to extract reserved words such as the above (“if,” “then,” and so forth). The parsing process can include procedures to form branching computing statements to accommodate IF-THEN-ELSE constructs, constraint statements, or translation into a logical structure or table representing a topological graph. Second, the NLP software may be used to generate a tree or similar topological graph structure of hierarchical clauses, making it possible to generate dependencies recursively.

For example, words such as “all,” “some,” and “none” may be identified, in a natural language processing context, as “DET” or “DT,” which as discussed above may indicate that these terms are “determiners” or “articles.” This may allow a FOL or HOL parsing tool to generate axiomatic statements to relate statements in English to operations on set theoretical constructs such as union, intersection, equivalence, existence, contingency, necessity, and uniqueness. For reference, the union of a collection of two or more sets may be the set of all elements of the collection, while the intersection of two or more sets may be the set of all elements common to each set. Equivalence may refer to certain terms being interchangeable for one another or otherwise equivalent. Existence implies that at least one example of a given entity exists. Contingency and necessity refer to prerequisite conditions for an entity to exist or a statement to be true, for example, the clause “if and only if.” Uniqueness may refer to the likelihood that a term has a particular unique definition, allowing for ambiguities to be reduced by the mapping of an appropriate ontology to the words and phrases as a whole based on more unique terms. (For example, “father” or “cardinal” may be less unique than “priest” or “pope.”)

The strategy for generating FOL statements for simple declarative sentences using a tree structure may, in certain exemplary embodiments, be as follows. First, parsing of the tree structure may begin at the root (ROOT). Each left parenthesis may be used to generate a new child tree node which may be inserted at one level higher than the present level in the tree structure.

As touched on previously, many NLP systems may use certain character codes (usually two or three-character codes) to encode parts of speech within the tree or similar topological graph, and these identifiers can be used internally to instruct the system as to the syntactic category of the word pointed to by the graph structure. For example, for internal processing and recordkeeping, “NP” may indicate a noun phrase, “VP” may indicate a verb phrase, “S” may indicate a sentence, “DET” may indicate a determiner/article, “N” may indicate a noun, “TV” may indicate a transitive verb (which takes an object), “IV” may indicate an intransitive verb, “PREP” may indicate a preposition, “PP” may indicate a prepositional phrase, and ADJ may indicate an adjective. Other such codes may also be contemplated. Similar internal recordkeeping devices may be used to separate nouns from proper nouns, verb tenses, and conflicting usage or alternative definitions of words. The output from the NLP program may be tokenized and structured into a topological graph that is internally processed by an exemplary system to track the parts of speech, and may map shorter clauses within the context of an entire sentence, as shown in FIG. 7, discussed later. For example, in one exemplary embodiment, all parsed text may be converted internally into arbitrary formats that keep track of the parts-of-speech labels, or into standard data formats suitable for mapping ontology, such as JSON. The system may track, through its graph structure, tables, and other computational data structures, the part of speech of each word in a sentence and the word's position in the graph generated by the NLP processor. Most importantly, the system may determine whether the word is a noun or similar object that will be a variable in an axiomatic function statement; whether the word connotes a quantifier such as “all,” “each,” “some,” or a conditional statement such as “if,” “then,” “else,” etc., that indicates a particular type of FOL or HOL axiom that needs to be generated; whether the term requires application of modal logic, such as an adjective, or probabilistic logic, such as “may” or “probably”; whether the term is a prepositional term such as “above,” “inside,” etc.; or whether the word is a verb or significant term that must initiate the formation of a new theorem. For nouns and verbs that lead to new theorems or new parameters in theorems, the system may be able to apply inherited characteristics of these terms that may be available in its knowledge base. For example, if a sentence states “Dogs like to eat meat,” all of the previously stored features, connotations, and assumptions for dogs, eating, and meat may be available to the inference engine and knowledge base.

It may likewise be contemplated to provide action terms, relationship terms, operators, or primary concepts that do not correspond exactly to some particular verb, noun, predicate, or other concept; for example, a given verb phrase may include a broad and general verb which may then be narrowed, or another concept entirely which must be interpreted in context in order to divine its meaning.

For example, it may be contemplated to provide an AI system equipped with an automated ontology system such as provided herein, which is configured to control household functions based on verbal instructions given by a user. A user may instruct the AI to “turn the lights off” or provide other language that may require further interpretation, such as “kill the lights,” and in each case (“turn off,” “kill”) the words may be identified as verbs and interpreted. However, as noted, it may also be desired to provide the system with an action to be taken by providing an action term, operator, or other primary concept in some other manner; the user could instead provide instructions to the system that “I would like the lights to be turned off” or “I would like it to be darker in here,” each of which would use the verb “to be” but would express the action terms in a more specific manner. As such, where the system would identify a verb, the system may instead identify the overall action term, operator, or primary concept as being the “verb” to be interpreted, where the “verb” is thus (for example) any tokenized identifier for an axiomatic statement. The same may likewise be true for any other concept under consideration; for example, similar collective nouns, collective predicates, and so forth may be contemplated.

In some exemplary embodiments, certain words or phrases appearing in the sentences themselves may also be identified as reserved words or reserved phrases, such as may be desired, which would serve as cues to initiate the construction of FOL or HOL axioms related to definition of lexical terms, set membership, negation, or equivalence. For example, according to an exemplary embodiment, the word “is” may be identified as a reserved word. In certain exemplary embodiments, reserved words may include similar words to “is” that may help in separating subject and predicate, making it easier to construct simple theorems. (Other variants may include, for example, other conjugations of “to be” like “are,” or even phrases like “is not.”) A word such as “is” may generate one of several different kinds of statements, including set membership (“a dog is a mammal”); definition (“squares are equal-sided rectangles”); equivalence (“Jane is Joan's niece”); temporary state (“the dog is hungry”); and so on. The system may apply a number of different methods for determining which kind of assignment to make, by keeping track of the context of phrases within a sentence, and the context of a given sentence with other sentences from the same text which the system keeps in its memory.

An exemplary embodiment of the system may include provisions for processing sentences constructed around notions related to time, transience, or temporal conditional states, reflected in the tense of an input sentence. Examples of possible time condition or tense in a sentence might include present, past, future; conditional, indicative, and subjunctive mood; perfect and imperfect aspects; and pluperfect and future perfect tenses, which may indicate periods of time other than the present. An exemplary embodiment of the system may construct algorithms that account for the implications of different tenses. For example, “John ran in the marathon,” is a statement about the past and conceivably a fact of record, whereas “John will run in the marathon if he feels well,” is a statement about a possible future that may or may not occur. The statement, “As of yesterday, John was considering running in the marathon next week,” involves a construct of future time embedded in past time, and in certain exemplary embodiments, the multiple layers of time could be built into the axioms that are produced, making it possible for the system to distinguish what has occurred from what may be planned or possible.

In certain exemplary embodiments, the system may operate to apply concepts of cardinality and number to input text. It could know how to count and add, and other mathematical operations, and reason out problems requiring enumeration, comparison, and quantification. An example might be mathematical word problems.

In certain exemplary embodiments, a separate classification may be created for proper nouns, such that nouns may be divided into proper nouns and improper nouns. The system may apply standard or novel data structures and programming methods to keep track of these distinctions. In an exemplary embodiment, proper nouns may be treated as specific instantiations of a general category. For example, “Zeus” is a proper noun, and “deity” is a general category of which “Zeus” is a specific instance. In some exemplary embodiments, a tree structure, graph, table, or a FOL/HOL structure may include references to the general categories which the proper nouns are specific instantiations of; for example, “Zeus” may be represented as “deity(Zeus),” (“Zeus”, deity) or some variant thereof, if desired. It may be contemplated for a given list or structure to be variadic, such that a given theorem has an arity of degree 1 or more; that is, the theorem may have one, two, or more operands. (For example, in one exemplary embodiment, it may be contemplated for “deity” to extend to a variety of gods, including both the Greek and Egyptian pantheons. “Zeus” may unambiguously be the name of the Greek sky god, whereas the Egyptian protector god Shed may need to be identified as “deity(Shed, person)” due to a shed also being an object, and certain deities who are seen as equivalent under the “interpretatio graeca” like Hermes and Hermes Trismegistus (used to refer to the Egyptian god Thoth) may need to be identified as “deity(Hermes, Greek).” Such variadic flexibility may likewise be applied to any other theorems such as may be desired.)

The system is capable of traversing NLP input/output, internal topological data structures such as graphs and trees, tables, etc.; that is, an exemplary embodiment of the system may operate to store all its information in whatever data structure most suitably preserves the information's topology, and the system can traverse the graphs using programming methods appropriate for such data structures.

After definitions have been assigned using a procedure such as the exemplary procedure defined above, subsequent text processing may be used to either provide additional definitions or instantiations of the defined objects. For example, according to an exemplary embodiment, the sentence “Jane is a girl” may, once run through an NLP system, produce the simple theorem “girl(Jane).” The object “Jane” may thus inherit all of the properties associated with conjectures generated for the definition “girl,” in addition to other theorems and conjectures assigned specifically to “Jane.” This may likewise work recursively, with “girl” inheriting the properties of “human,” “human” inheriting the properties of “mammal,” “mammal” inheriting the properties of “animal,” and so forth. Terms may also inherit properties associated with conjectures generated for multiple different terms; for example, “girl” may imply “human” and “female” and “juvenile,” and may inherit all of the properties of each. Each of these may be invoked similarly, as, for example, “human(girl),” “female(girl),” “juvenile(girl),” and so on and so forth with any other terms such as may also be used. Furthermore, the article “a” may be used to instruct the system to tag the instantiation “Jane” as a subset of “girl,” rather than an equivalence of two identical entities. This may likewise be the case with any other terms, such as, for example, “deity(Zeus).” Mutual inheritance may also be contemplated, in the case of certain words being synonyms; for example, if “deity” and “god” are treated as synonyms, then both “deity(god)” and “god(deity)” may be invoked. As such, in this manner, objects may function as tokens representing theorems themselves, such as may be desired, allowing theorems to be referenced iteratively (as with “girl”) or recursively (as with “deity”) in an object list as provided above. Recursive processing may also be applied to multiple clauses in sentences with complex structures. For example, in the sentence, “If Jane can convince Frank, he would become one of the members of her team,” recursive processing could be carried out on the successive clauses, thus building a graph structure of theorems that reference other theorems. (Still other variants, including aspects like partial inheritance, may also be contemplated, if desired. For example, a definition provided for “god” may be associated with some probability that the character in question is male, whereas “deity” may be gender-neutral; as such, it may be contemplated to have “deity” inherit from “god” all of the properties associated with conjectures generated for the definition “god” apart from those associated with “male.”)

For example, for the sentence, “Zeus is the father of Apollo,” the translation of the NLP output illustrated in FIG. 1, “<parse>(ROOT (S (NP (NNP Zeus)) (VP (VBZ is) (NP (NP (DT the) (NN father)) (PP (IN of) (NP (NNP Apollo))))) (. .)))</parse>” may be parsed in a manner analogous to the behavior of a compiler. For example, according to an exemplary embodiment of a parser, parsing of the above NLP output may include the following steps. In a first step, the NLP output tree may be traversed from the leaves through the nodes (upwards) and backwards (right to left). For example, parsing may start with the word “Apollo” in this case.

In the above tree, “Apollo” may be identified as an instantiation with stored properties NP and NNP, identifying it as a noun phrase and a proper noun phrase, respectively. Next, “of” may be determined to have property IN. Next, the PP property for “of Apollo” may send a message that the next concept preceding “of Apollo” should reserve a placeholder for “Apollo” in the second position of the expression being formed; that is, the token “Apollo” is the object or predicate in this arbitrary protocol. The theorem, then, may initially contain the terms “x(x, “Apollo”).”

The expression “the father” may then likewise be parsed in a similar way. In this case, however, “father” may not be a proper noun; instead, “father” is identified as NN rather than NP, and therefore may be tokenized as a function rather than a variable in the theorem. As such, thus far, “the father of Apollo” may be translated as “father(x,Apollo).”

Next, “is” may be parsed. Parsing “is . . . ” may indicate that the subject in the expression about to be parsed is to be assigned in the position of x in the Father theorem. Once “Zeus” is parsed, it may be assigned there. That is, the parser may parse “Zeus,” assign properties of NP and NNS, and replace x in the expression with Zeus. The final expression may thus be “Father(Zeus,Apollo).” This sentence may be ingested into the list of theorems. As noted earlier, an exemplary embodiment of the present system may be configured to recognize the presence of “is” as a cue to set up a new theorem or axiom representing an equivalence or set membership, and the presence of the word “the” may function as a cue to set up an axiom that indicates uniqueness or equivalence rather than set membership.

It may be noted that, in an exemplary embodiment, general terms such as “whoever” or “the person” may be translated into variables such as “x” and “y.” Lowercase for arguments and parameters may be used for a theorem prover such as PROVER9 to indicate that the terms are variables rather than instantiations; other conventions may be employed when using other software frameworks or other programs, such as may be desired.

Upon the completion of the first through fourth steps, an exemplary embodiment of the system may perform hypothesis testing based on the generated FOL or HOL axioms. For example, in an exemplary embodiment wherein the system is parsing particular text, the hypotheses generated by the system may be checked by human intervention in order to determine if the ontologies generated are reasonable. (In some exemplary embodiments, a system may perform some level of self-checking, based on the probabilities associated with applying any one particular ontology, and may highlight the areas it has determined to have the lowest probabilities of matching the ontology in order to direct the human oversight appropriately. For example, according to an exemplary embodiment, when there is a high level of ambiguity about whether “Father” is referring to a parent or a priest, a system may choose one or the other based on a calculated probability, and may highlight the largest contributing factors to its lessened level of certainty.)

Exemplary embodiments of the system may make use of prior and subsequent clauses, sentences, paragraphs, and supplementary documents or other sources of information which may be stored in memory or accessed during processing, to establish the context of such phrases and potential interpretations. For example, in the sentence, “Mary had a little lamb; its fleece was white as snow,” the system may interpret the anaphoric word “its” as referring to the lamb, and set up an axiom designating the lamb as the possessor of the fleece with the modal qualifier “white,” which itself may be given a qualifier to make the comparison with snow. Similarly, the system may make use of cataphoric pronoun references, such as “when it saw Mary, the lamb leapt for joy.” This operation of binding with antecedents with pronouns may require forming associations across multiple sentences, paragraphs, or sections of documents. In general, pro-form words such as “there,” “this,” “more so,” “that one,” etc., may be interpreted by association with nearby terms; an optimization process of forming multiple constructed interpretations in the form of graph data structures may be used to find the interpretation leading to the best disambiguation of terms, as measured by a metric that may account for the ability of the system to form a proof consistent with pre-existing axioms. The resolution of ambiguities may involve iterative passes through a document or set of documents, or recursive attempts to construct multiple graphs followed by quantitative evaluation of the fitness of interpretation.

Hypothesis testing may also be performed automatically, if desired. For example, it may be contemplated to have the system retrieve lower-reliability data (for example, from automated internet searches) which are available in higher quantities, and retrieve higher-reliability data (for example, from dictionaries or from trusted sites) which are available in lower quantities. The ontology that is created as the result of Internet searching may be checked against the ontology created based on the dictionary in order to assess the overall accuracy of the ontology created via internet searching. Exemplary embodiments of the system may make use of available or specially constructed “common-sense” ontologies; that is, ontologies that record many commonly assumed facts of existence, such as “fire is hot,” that may be neglected by typical databases due to the volume of such minutiae. The ability to reference millions of stored facts makes it possible for the system to establish layers of ontology, distinguishing facts that are globally true from details of a set of statements that may only be locally true within a particular set of text, and to quarantine itself against deliberately or inadvertently introduced false information.

This may allow for easier implementation of NLP parsing and conjecture generation capabilities. As touched on previously, such capabilities may be progressively more difficult to develop based on a large size or low search feasibility of the ontological basis, with the most challenging problems being identified as “AI-complete.” (This terminology is used to imply that the difficulty of solving said computational problems conclusively is equivalent to that of solving the central artificial intelligence problem, and requires making computers as intelligent as people, or so-called “strong AI.”) For example, the Second Edition of the 20-volume Oxford English Dictionary contains full entries for 171,476 words in current use, and 47,156 obsolete words. To this may be added around 9,500 derivative words included as subentries. (These words include words that have multiple highly distinct meanings which may be defined separately; for example, “dogs” may be a plural noun, referring to multiple canines, and also may be a present tense of a verb that means “follow someone or their movements closely and persistently.”) Numerous other phrases have a meaning that is distinguishable from, or even entirely distinct from, their component words; for example, the phrase “dog-tired” may use the word “dog” to provide emphasis, not to imply the presence of any canines. Numerous words with identical meanings may also have multiple variants (for example, “hotdog,” “hot-dog,” and “hot dog” are all used). While the connectivity of many of these words with one another is linear, many axioms may be required in order to encode the relationships between the words in an ontology, which may in common usage be provided by shared experience and must be formulated in such a manner as to replicate the shared experiences that make it possible to encode meaning efficiently for human listeners. Alternatively, the system may be able to formulate such axioms on its own through internet searching or other textual searching, such as searching of books, newspapers, official records such as the Congressional record, and so forth, which may include all sorts of text including text formatted conversationally.

Such processes may ensure that, in some exemplary embodiments, domain knowledge does not have to be encoded entirely by hand or even at all by hand. In an exemplary embodiment, automated internet searches may be used to harvest vast quantities of domain knowledge, the searched information may be subject to any preliminary screening that may be appropriate, and procedures such as are described herein may be used in order to translate the domain knowledge into FOL and HOL axioms. Such procedures may be applied to various types of NLP architecture, such as a convolutional neural network (CNN) NLP architecture, such as may be desired. Such procedures may also be applied to other systems including systems not involving text data; for example, it may be contemplated to apply such systems in connection with a CNN equipped to analyze image data in order to encode knowledge obtained via the CNN into axioms related to image analysis. According to an exemplary embodiment of an application for image data, it may be contemplated to have the application make use of a feature detector or automatic target recognition algorithm to identify features in the image scene (often referred to as “semantic” features), and to conduct analysis on the text, word vector, word embedding, or topological graph structures created by the system for the semantic elements. Similarly, mapping data in digital form may be processed with these procedures; for example, vector-based feature foundation data such as may be stored in geographical information systems may be processed with these methods, possibly in conjunction with some of the other formats mentioned above. Hand-drawn representations of images, maps, and other types of sketches may be processed in a similar way to encode features into a topological graph structure which is processed using the methods described herein. Furthermore, data fusion of information from multiple data types simultaneously or in aggregation may be applied. For example, if an audio track accompanies a video, the spoken words can be processed for their information content with NLP and the other techniques described above, and the detected visual features of the video can be associated with the axioms. That is, if a sentence is spoken, the system can tag the identity and other characteristics of the speakers, using conventional computer vision and speech recognition techniques. In doing so, all visible features, spoken or written words, vocal inflections, speaker identity and characteristics, etc., can each be assimilated and associated with one another in the knowledge base across the various modalities. Similar processes of data fusion can occur to combine image data and mapping data, drawings (including technical drawings such as technical diagrams) and photographs, and any other applicable type of data. In an exemplary embodiment of the system, a similar processing methodology may be applied for all data: the features and relationships may be abstracted into axioms and assimilated into the knowledge base and inference engine. (It may likewise be contemplated for output to be varied in the same manner as input; for example, methods of output may include multiple or combined forms besides text, such as audio and visual representations such as imagery, video, sketches, or maps, which may be used to represent the logical features of the output.) The translation of visual features into a graph-like structure suitable for an inference engine could be applied in an exemplary embodiment of the system, to solve visual and spatial reasoning problems which are not presently amenable to computer vision methods that lack such a representation of the logical relationships between the visual features. Examples of such problems include the following: determining a narrative for a visual scene based on subtle visual cues, such as shadow direction, relative position, configuration, posture, and orientation of objects or persons in the scene; answering geometric queries, such as, for example, whether a line of sight exists between two buildings, whether one automobile is in a scene following another, whether a person is in the scene walking toward the sun, and so on; solutions to visual representations of topology problems, such as the Seven Bridges of Konigsberg; problems involving three-dimensional interpretation of two-dimensional scenes, such as questions about the possible path of projectiles, the potential effects of rotating or displacing objects in the scene, navigation strategies, estimating the distance between objects, the relative geometric position of the camera or observer with respect to the scene, or determining whether a road or path connects two objects in the scene. An exemplary embodiment may be configured to construct axioms, conjectures, and hypotheses for the semantic visual features identified in the scene by extrinsic methods, and could thus solve spatial problems from image, diagram, and mapping data, as humans do, and express the solutions in various combined forms, as noted above.

As previously discussed, it may also be contemplated to automatically encode levels of uncertainty into the system, associated with some or all words or phrases or even whole sections of the ontology. For example, while it may be easier to have a system that makes use of FOL and HOL statements that are assumed to be true, with no uncertainty, ambiguity, incorrectness, falsehood, or incompleteness, in other exemplary embodiments, the system may be configured to deal with false statements (whether deliberately false, factually incorrect, or some combination of the two) through optimization. For example, if the system acquires new information that is inconsistent with old information, the new information may be discarded, if desired. (Alternatively, the old information may be discarded, if desired, or some level of “baseline” information may be reverted to. For example, according to one exemplary embodiment, a system may start with a dictionary or stored ontology definition of a term, identify the word as being used in some particular manner when conducting an Internet search or other text data search, and then identify a contradictory usage. In this case, the system may discard both sets of information and roll back to the trusted dictionary or previously held definition to ensure accuracy.) The system may also account for concepts associated with probability, possibility, likelihood, feasibility, and other quantifier terms that may be associated with fuzzy logic or belief.

It may also be contemplated that, in some exemplary embodiments, the assumptions that lead to discarding of information may be tracked, as well as the acquisition of information consistent with those assumptions. If a set of assumptions leads to discarding of too much information beyond some limit, contradictory FOL or HOL assumptions may be suspended, and new FOL or HOL assumptions devised. In certain embodiments, a “limit” or threshold may be predefined, such that, for example, ten or a hundred contrary uses cause the contradictory FOL assumptions to be suspended. In other exemplary embodiments, a “limit” may be defined in relative terms, such that a number of contrary uses may be observed so long as it does not go over 1% of the total or some other predetermined threshold. The system may then be configured to identify an ontology that discards the fewest given assumptions or new information, optionally with such terms being weighted based on a level of certainty or some other valuation such as may be desired; the identified ontology may be selected as an optimal ontology, until or unless it becomes contradicted by other assumptions. (For example, it may be contemplated that a system may weight information that comes from certain sites more highly than others, such that a published article may be treated as being more likely to have used words in a reliable and correct manner, and may be treated as a good source of domain knowledge, while the content harvested from a social media site such as TWITTER may be treated as being less likely to have used words in their proper context. As such, the published article may be weighted more highly and the social media site may be weighted lower. This may mean that, in absolute terms, a more significant number of observations may be associated with the social media site, but the published article may be weighted more highly despite a relatively low number of observations, due to the weighting applied to the source.)

Alternatively, another method of generating an optimal ontology, other than identifying the set of assumptions and theorems that discards the least number of given assumptions or new information, may be used. (For example, as touched on previously, a “base ontology” derived from a dictionary or existing common-sense ontology may be generated, and other sources may be assigned reliability scores based on the degree to which data derived from the source matches the pre-existing ontology in the system. A source which produces a very close match may be assigned a high reliability for data not in the existing ontology, whereas a source which does not closely match the existing ontology data may be assigned a lower reliability, and a higher number of observations or more consistency in the observations may be necessary for data from that source.) This may ensure that it is possible for the weight of evidence to induce a paradigm shift in the FOL assumptions and theorems, even for words that may have common usages contrary to their everyday meanings in the dictionary (for example, “literally” or “ironic”), or which may not appear in a dictionary (for example, until recently, “googling” something was a commonly used term for searching that did not appear in the dictionary; this may likewise be the case with other such terms).

As discussed, the automated translation of natural language text into FOL or HOL format may allow the generation of ontologies from large amounts of text data. However, it may also be contemplated to employ it for other systems, such as images or video data. In one contemplated exemplary embodiment, it may be contemplated to apply the text ontologies to images or video data in order to assist automated systems in constructing narratives from images and video data, and likewise may be contemplated to, vice versa, apply ontologies developed from visual semantic features to text data. The data fusion of information from text sources, audio sources, and visual sources in combination within the graph structure of axioms makes it possible to integrate all of these sources of information into a common knowledge base that efficiently encodes common-sense precepts beyond the capabilities of prior art. The procedures outlined in this summarization represent a possible practical means of developing AI systems that can approximate thinking or which even get closer to “strong AI.”

In some exemplary embodiments, for example, once an accurate ontology has been generated, the ontology may then be used in a robotic system that may be used to read text or listen to spoken language in such a manner that it can process the text, and generate useful and original responses to a user's input. This may allow the robotic system to respond or reply to the user in a manner based on some level of comprehension of the input sentences, and the application of said input sentences to a logical system based on data stored in a taxonomical format, with a vast storehouse of minute facts that include common sense knowledge, minutiae, and the assumptions that are accumulated from everyday experience.

In exemplary embodiments of a robotic system, the system may be formed from three main core elements, as are generally described above. A first element may be a natural language processing (NLP) syntactical sentence parser, which may be configured to generate tree structures similar to those discussed above. A second element may be an automated theorem prover (ATP) formatter, which may be used to format the tree structures generated by the NLP syntactical sentence parser into a structure ingestible by the ATP software. The third element may be the ATP software or inference engine itself, which may operate on the formatted tree structures to generate and use the desired ontology. The system may then be coupled to various hardware devices, such as a microphone system configured to receive and interpret the speech of a user, or a text input system, such as a smartphone or other computer system configured to send and receive messages from a server operating the system, or a computer system operating a local copy of the system, or some combination of the two (such as a computer system operating a smaller local copy of the ontology on a local system or cache based on the most commonly used words and common-sense concepts, and accessing a larger full copy of the ontology on a server based on all available words, or detailed minutiae, or some other set such as all non-obsolete words, such as may be desired). The system may also be configured to read existing ontologies directly from storage media, rather than processing in the usual way from text input, and may be configured to combine the two methods, as desired. For example, it may be contemplated to load an existing ontology directly from storage media and then further develop the ontology based on processing from text input in order to incorporate new concepts.

According to an exemplary embodiment, the system may be configured to converse with human listeners in such a way as to demonstrate some level of human-like understanding. This may distinguish exemplary embodiments of a robotic system from present systems, which may be incapable of comprehension of text, and may instead rely on other devices constructed mostly or entirely by human intervention in order to respond to human queries, or on superficial syntactic cues from intermittent word recognition. For example, it may be contemplated that other devices may be confined entirely to the use of such methods as unprocessed data retrieval from massive databases, or statistical processing of input sentence structures through methods like word frequency counting and n-grams in order to imitate human understanding of sentence subject and sentiment, in order to provide any breadth of application. For reference, “n-grams” describes a process by which statistical processing is performed for text in order to identify word frequencies, after which the co-occurrence of related words and concepts may be identified. From the identification of co-occurrent words and frequencies, co-occurrent words may be identified in appropriate contexts (such as in auto-suggestion programs for use as a typing or text input aid).

Alternatively, other systems and methods in use may be forced to highly constrain the applications in which these systems and methods can be used in order to provide more effective responses in these limited windows of application; for example, some systems and methods may be forced to make use of highly formatted input/output query languages that cannot handle inputs not compatible with these input and output requirements. Other systems and methods may be able to make use of input/output constrained to specific types of questions and answers, which may be effective when answering those highly limited types of questions but may not necessarily be effective under other circumstances. (These may include, for example, robotic speech recognition systems used for customer service in various applications, such as automated billing or menu navigation, automated reservation requesting or check-in for travel such as telephone reservations on trains and the like, and so forth. This may also include, for example, the MICROSOFT CORTANA, the APPLE SIRI, or the AMAZON ALEXA virtual assistant programs, or any other such programs that may be contemplated.)

It is contemplated that, in exemplary embodiments of a system for integrating ATP and NLP, such features may also be incorporated, if desired. For example, it may be contemplated that, in some circumstances, unprocessed data retrieval or statistical processing of input sentence structures, or any of various approaches that may be used with highly formatted input/output query languages or other forms of constrained input/output, may be quicker or require less processing (or could be more accurate) than the use of an ontology system. As such, it may be contemplated to have an ontology system be used as a fallback system; in one exemplary embodiment of an automated ontology system, the system may be configured to search a database for an existing answer, and, if no existing answer is identified, may be configured to automatically formulate its own answer based on an ontology generated using the ATP software.

In certain embodiments, a different process flow may be contemplated, such as a blend of the two. For example, in response to a particular user query, the query may be processed using NLP and an ATP-based ontology may be used to interpret the query, identifying a topic of interest. An appropriate database may then be searched for a predetermined response to the query. If no predetermined response to the query can be identified, then the system may use either a general-purpose ontology or a topic-specific ontology, such as a legal ontology emulating a legal dictionary, a programming ontology which gives higher weight to programming terminology, and so forth, in order to formulate a response to the query.

According to an exemplary embodiment of an automated ontology system, a system may generally function according to the following principles. As articulated previously, the system may integrate ATP with NLP. The system may then employ formatting methods such as are discussed above in order to translate NLP output into ATP theorems and axioms. The system may use new syntactic parsing methods such as previously discussed to construct ATP theorems and axioms from text processed by NLP, which may overcome problems like those discussed above as well as numerous others. (For example, according to exemplary embodiments such as those making use of the rules articulated previously, certain problems anticipated to be caused by the combination of ATP and NLP, such as problems associated with recursively constructing ATP theorems from complex sentences.)

The system may also be able to correct numerous problems that may occur when parsing inputs that may not be solvable by present systems. For example, in present systems equipped to perform structured-language parsing techniques (such as compilers and other programs equipped to parse structured programming language), it may be contemplated that non-structured language may present numerous incompatibilities that prevent structured-programming solutions from being employed. Exemplary embodiments of the presently recited system may allow the application of structured-language parsing techniques to non-structured language by dividing input words (which as discussed may be formatted as NLP tree nodes in some exemplary embodiments) into several categories. For example, sentences may be divided into essential characteristics, such as primary subjects, objects, and actions (that is, nouns and verbs), with other words being handled separately. Adjectives and adverbs may be contemplated as being secondary characteristics, which may affect the primary characteristics. Further, the system may, in some exemplary embodiments, contemplate the use of a list of reserved words, such as “if,” “then,” “else,” “or,” “and,” “not,” which may be used to guide construction of first-order or higher-order logical statements that can be translated into ATP theorems and axioms. This may offer improvements over existing context-free grammar parsers by being able to handle context-sensitive, ambiguous, natural language.

An exemplary embodiment of the present system may be configured to perform the following steps. Prior to response to any user query, the system may obtain a first set of rules defining a knowledge domain, obtain a data file of ingestible information, generate a tree structure based on the ingestible information, and convert the tree structure into at least one tree structure first-order or higher-order logic axiom. (This may be through NLP if the data is text data; other methods may be contemplated for other types of data, such as image or video data.)

The system may then store a plurality of first-order logic axioms in a memory, this plurality of first-order logic axioms including the at least one tree structure first-order logic axiom. The system may then formulate and test one or more conjectures, the one or more conjectures including a first-order logic axiom not otherwise provided, wherein formulating and testing the one or more conjectures includes generating, based on the plurality of first-order logic axioms, at least one intermediate theorem, and generating, based on the plurality of first-order logic axioms and the at least one intermediate theorem, a conjecture test result, the conjecture test result being an indication that a conjecture in the one or more conjectures is one of true or false. When the conjecture in the one or more conjectures is true, the system may store the conjecture in the memory in the form of an ontology, whereas when the conjecture is false (including both circumstances where the conjecture is untrue and circumstances where the conjecture is unproven from available evidence), the system may iterate, formulating and testing one or more additional conjectures and testing those instead. The system may then receive, from an input system, the user query, and may map the user query to the ontology in such a manner as to allow it to be interpreted using the ontology. The system may then generate and output, based on the user query and the ontology, the response to the user query.

In an exemplary embodiment wherein the data are text, the tree structure may originate from a natural language processing (NLP) tree structure representing at least one phrase and including a plurality of pairings of syntactic categories and words in the text data. This may also be the case if the data are converted into text using speech-to-text or other such conversion methods. (For example, a separate converter program may be used to identify components of an image, such as a program to extract subtitle data from a video, or read information from a sign in an image frame, or a bag-of-words summarization of semantic features in an image, and so forth.)

The step of converting the tree structure into at least one tree structure first-order or higher-order logic axiom may include steps of identifying a verb in the tree structure, and automatically creating a theorem based on the verb; identifying a subject in the tree structure, and adding it to an object list (or some other multi-element data structure); identifying a predicate in the tree structure, and adding it to the object list; and providing the theorem as a tree structure first-order or higher-order logic axiom of a form such as “verb(object list).” In some exemplary embodiments, modifiers may also be added, such as adverbs and adjectives; in such exemplary embodiments, the step of converting the tree structure into at least one tree structure first-order logic axiom may include steps of identifying a verb in the tree structure, and automatically creating a theorem based on the verb; identifying a subject in the tree structure, and adding it as an object in an object and feature list; identifying a predicate in the tree structure, and adding it as an object in the object and feature list; identifying at least one modifier of at least one of the subject or predicate, and adding the at least one modifier as a feature in the object and feature list in association with the at least one of the subject or predicate; and providing the theorem as a tree structure first-order logic axiom of the form “verb(object and feature list),” wherein the object and feature list includes at least one object-feature pairing (such as “object, feature 1”). Finally, as stated earlier, the subject and predicate portions of each sentence may themselves include multiple clauses that may be processed recursively, and the terms therein may be linked or bound to other terms in the sentence, or in other portions of the same document. For example, pronouns such as “she” or “it” in anaphoric or cataphoric expressions may be associated by algorithm to names or proper nouns given elsewhere, as described earlier.

In some exemplary embodiments, the system may use contextual knowledge from intrinsic or extrinsic sources to interpret pronouns and other terms that are not proper nouns, and bind the nonspecific terms to other objects in its knowledge base. For example, in a sentence such as “Jane read a book, and she enjoyed it,” the system would understand that the word “she” pertained to “Jane,” and “it” pertained to “book.” It may be contemplated that, in some circumstances, the system may lack a clear way to do this; for example, in a sentence such as “Jane talked to Alice, and she enjoyed it,” the system may not be able to resolve that the word “she” actually pertained to Jane rather than Alice, or that it did so within an acceptable degree of probability. In such an exemplary embodiment, it may be contemplated to have the system note the ambiguity and its context and request human intervention, such as by providing an alert to a particular user to resolve the ambiguity or by flagging the determination for later review and possible recalculation of elements of the ontology.

The system may be configured to construct hypothetical environments, such that some statements pertain globally across multiple domains, and some statements pertain to subjects that are restricted to particular or localized domains. For example, if the system is used to understand a story, the system can be configured to make assertions, conjectures, and conclusions that pertain only to the world of the story, rather than globally, and vice versa. (A simple example showing the difference can be seen in the comparison of two sentences: “All men are created equal,” and “All the men played pool.” Similar processes establishing sensitivity to context can be applied to resolve metonymy, synecdoche, or toponymy, for example, “The Pentagon brass made a call to arms.”) The system may use a memory design partitioned to allow some axioms to be true only in a particular domain; for example, “Dracula is a vampire taking the form of a bat” can be excluded from biological knowledge bases about bats.

It may be contemplated, in some exemplary embodiments, for the system to create temporary virtual constructions representing hypothetical scenarios, such as in a word problem. For example, consider the word problem, “If Frank has five apples in a cart, and one falls out, how may apples are left in the cart?” Such a question may be resolved by creating a hypothetical character, Frank, and the scenario of five apples in a cart with one falling out. The system would understand through its common-sense knowledge base that one apple falling out means one fewer apple in the cart, and the problem would be reduced to a familiar math equation that can be evaluated and solved. The “apple cart” framework may then be reconstructed by the system around the answer; since the system has identified that these are “apples” falling out of the cart, the resulting answer may be “four apples.” The ability to apply common sense and construct imaginary hypothetical scenarios is beyond the capabilities of current question-answering systems such as ALEXA.

Similarly, the system may use processes to form hypothetical scenarios for sentences or phrases that require presupposition. For example, in the sentence, “If Mary's father sees the lamb, he will bring it back to the pasture,” the presuppositions may include Mary having a father, and the lamb being outside the pasture.

In some exemplary embodiments, the system may be configured to automatically further develop the ontology, such as by conducting web searching or by monitoring users. For example, user queries may be shared with other systems or added to a shared ontology. Likewise, it may in some instances be contemplated to record non-query audio data for further processing, if desired.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary flowchart depicting an exemplary embodiment of a process for constructing an ontology for use in an automated ontology data comprehension system.

FIG. 2 is an exemplary flowchart depicting an exemplary embodiment of a process for constructing an ontology for use in an automated ontology data comprehension system.

FIG. 3 is an exemplary flowchart depicting an exemplary embodiment of a process for constructing and using an ontology with an automated ontology data comprehension system.

FIG. 4 is an exemplary flowchart depicting an exemplary embodiment of a process for constructing and using an ontology with an automated ontology data comprehension system.

FIG. 5 is an exemplary embodiment of computer code depicting an exemplary set of axioms that may be used in a conjecture generation program.

FIG. 6 is an exemplary embodiment of a proof generated by an automated theorem prover according to an exemplary embodiment of the present system.

FIG. 7 is an exemplary tree-structured graph illustrating the Natural Language Processing output for a sentence.

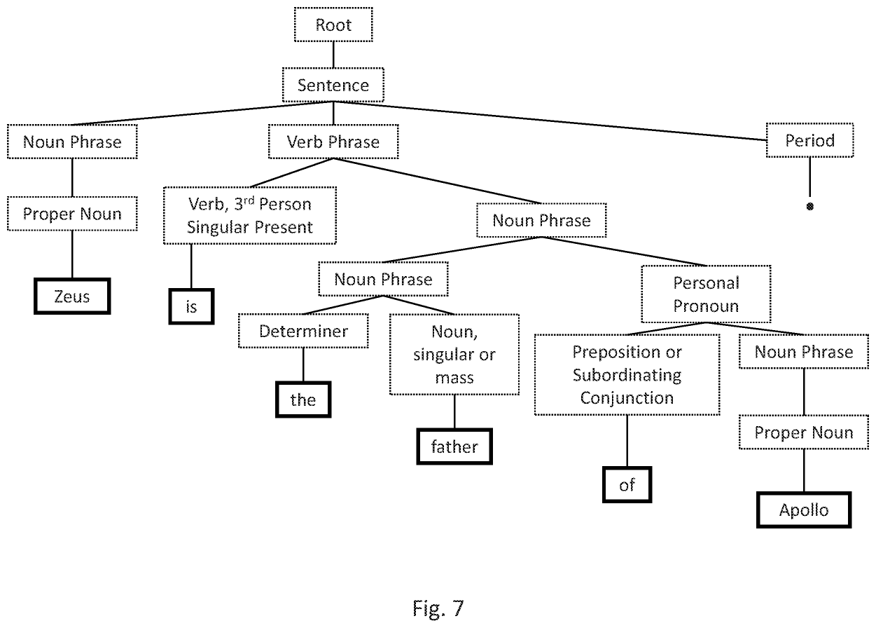

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

According to an exemplary embodiment, and referring generally to the Figures, various exemplary implementations of an automated ontology system may be disclosed.

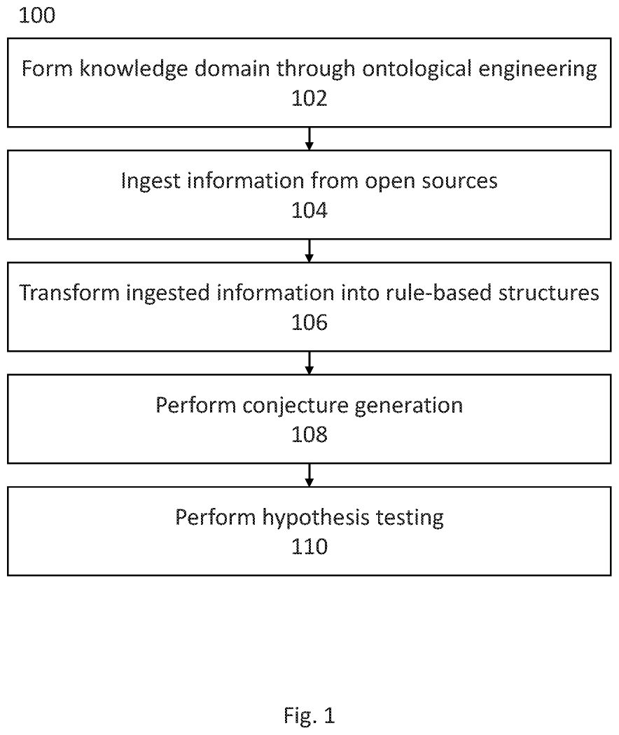

Turning now to exemplary FIG. 1, FIG. 1 is an exemplary flowchart depicting an exemplary embodiment of a process for constructing an ontology for use in an automated ontology data comprehension system 100. According to an exemplary embodiment, in a first step 102, a knowledge domain may be formed through ontological engineering. In a second step 104, information may be ingested from a set of sources, such as through dictionaries, higher-quality or professional sources such as published literature or published scholarly articles, through existing knowledge bases or ontologies, or through open-ended web searching (or any other method of information ingestion such as may be desired). Information ingestion may be completely automatic (for example, automatic web crawling), if desired; alternatively, one or more sources may be provided manually, and may be given greater priority or greater weight if desired. In a third step 106, the ingested information may be transformed into a set of rule-based structures. In a fourth step 108, the system may perform conjecture generation to generate one or more conjectures. In a fifth step 110, the system may perform hypothesis testing in order to generate the ontology based on the resolution of the hypothesis testing. For example, according to an exemplary embodiment, the system may iterate through a variety of hypotheses, checking them against the collected data and refining them as appropriate through successive conjecture generation 108 and hypothesis testing 110 steps. Once the generated hypotheses are all tested and resolved to a desired level of accuracy, the system may indicate that an ontology has been successfully generated based on the generated conjectures 108, and the ontology may be available for future use. Alternatively, if the system cannot reconcile its conjectures through hypothesis testing 110, the system may collect more data by ingesting information from additional open sources 104 until the hypotheses can be resolved one way or the other. (For example, additional searching may cause the system to identify additional data sources that its trustworthiness criteria indicate should be weighted more highly, such as additional dictionaries or scholarly articles, and the weight of the additional data may push certain hypotheses above a desired probability threshold. In another exemplary embodiment, additional searching may lead to old data being reevaluated and discarded in favor of the new data. Other such variants may also be contemplated, such as may be desired.)

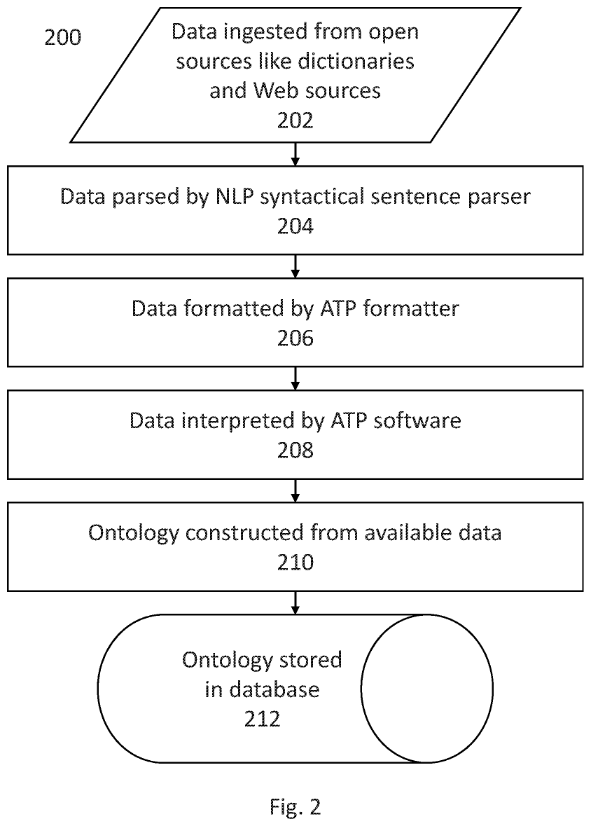

Turning now to exemplary FIG. 2, FIG. 2 is an exemplary flowchart depicting an exemplary embodiment of a process for constructing an ontology for use in an automated ontology system 200. According to an exemplary embodiment, data may be ingested and transformed into an ontology according to the following structural diagram. First, data may be ingested 202 from one or more sources, which may be open sources like dictionaries or Web sources, or may be more directed (e.g. just dictionaries, just digitized books, just digitized books from a certain date range, and so forth). Next, data may be parsed 204 using a syntactical sentence parser, and may then be formatted 206 using a formatter configured to properly format the data in ATP format as discussed previously. The data may then be interpreted 208 by the ATP software in order to determine a set of hypotheses which are considered to have been proven, above a desired level of certainty. An ontology may then be generated from the solved hypotheses 210. This ontology may be stored in a database 212.

According to an exemplary embodiment, NLP output from the NLP syntactical sentence parser 204 may be formatted as a tree formed from nodes made from the words in the sentence, which may graph the syntactic dependency based on the Penn Treebank format. That is, words may be designated as nouns, verbs, and other parts of speech, and the sentence may be parsed as a recursive graph structure that maps the grammatical dependency of subjects and predicates.

Such a system may overcome existing problems with automated systems that prevent them from extracting more than superficial conceptual information from NLP output. This may be due to several issues, each overcome by the present system, following a process such as that described in FIG. 2.

First, existing automated systems may have no framework for incorporating prior contextual information. Lacking such information may cause them to struggle even with basic matters of interpretation, such as dictionary referencing and retrieval. For any given object, it may be understood that human beings, or another group of which the expected user may be a part (such as, for example, “English speakers” or “Americans”) may have a framework of prior understanding of the concept which machine learning systems lack, and which, because of the commonality of such understanding among human beings or other expected users, may not be explicitly incorporated into reference material.

Second, NLP output is incompatible for ingesting into existing taxonomies, or ontological structures, simply because of incompatibilities in the data structures that must be resolved.

Third, and potentially most crucially, existing systems have no method of inferring cause or consequence, generating conjectures, or reasoning. This means that existing systems have no real ability to interpret data other than based on predetermined questions and answers in a database or statistical word matching.

The so-called “Chinese room” thought experiment essentially describes the most capable existing systems. In this thought experiment, a monolingual English speaker is locked in a room, and given a large batch of Chinese writing, plus a second batch of Chinese script and a set of rules in English for directly correlating the second batch with the first batch. The rules correlate one set of formal symbols (i.e. the symbols are identified by their form or shape, also called “syntactic” symbols) with another set of formal symbols. A third batch of Chinese symbols and more instructions in English enable the English speaker to correlate elements of this third batch of Chinese symbols with elements of the first two batches and instruct the English speaker, thereby, to give back certain sorts of Chinese symbols with certain sorts of shapes in response. Regardless of the performance of the system, it can brook no deviations from protocol and cannot handle any situations not defined by the English instructions. At best, when given a new symbol, the system may be able to discover a proper response through trying symbols at random and determining which are and are not acceptable.

The present system provides a framework for harnessing an automated theorem prover to generate logical consequences from input statements and test the validity of conjectures. As discussed, ATP has been used to test hardware systems and prove the truth and soundness of theorems. ATP systems can provide an underlying framework for an AI system that understands and responds to spoken or written statements translated into the proper format. However, ATP systems require precise, highly formatted input (based on predicate calculus). The remainder of the system provides a reliable method of generating that input from natural language, which is often ambiguous and imprecise.

For example, one format suitable for ATP is the following format: “Theorem_name (Object1, Object2, Object3, . . . , ObjectN).” In this nomenclature, “Theorem_name” may correspond to the verb of a sentence or phrase, and “Object1” and “Object2,” etc., may correspond to subject and predicate of a sentence. This strategy is easy to implement and has been tested for simple sentences. For complex sentences, the strategy is implemented recursively; for example, Object1 and Object 2 may themselves be phrases that can be reduced to the same semantic structure. According to such an exemplary embodiment, they may be folded into tree structures which would be tokenized (labeled as separate entities) and ingested as axioms into the system.

As touched on previously, the presence of modifiers such as adjectives and adverbs complicates this procedure. Part of the difficulty of parsing natural language is determining whether the modifiers are essential, or whether the qualities are circumstantial and accidental. Exemplary embodiments described herein address the problem by introducing an alternative theorem structure, “Theorem_name(Object1, Feature1-1, Feature1-2, . . . , Object2, Feature2-1, Feature2-2, . . . ),” which likewise may be extensible as necessary to include as many features and as many objects as desired. Such structure ensures that secondary characteristics can be accounted for in such a manner as to allow the axiom database to be searchable and functional at the same time. In some exemplary embodiments, file formats such as JSON may be applied as a method of formatting data so as to clarify distinctions between essential and accidental features of objects in the knowledge base.

As also touched on previously, as noted, in some contemplated exemplary embodiments, conditional language expressions such as “if” and “else” phrases may not be literally reducible to a theorem structure such as is contemplated above. Therefore, in some exemplary embodiments, a parsing algorithm may be introduced, which may be operable to build axiom expressions from the phrases in which these terms appear. For example, the statement “if A is a snake, A is a reptile” would be parsed into a standard first-order logic theorem structure as “-snake(A)|reptile(A).” (As previously explained, such a statement would literally equate to “at least one of these is true: A is not a snake, OR A is a reptile.” Both, of course, can be true; something can be a turtle, for example, and be both not a snake and a reptile. In such a circumstance, the statement will remain true. The same is true for other such statements, like “-parent(x,y)|ancestor(x,y),” where something can be both not a parent and an ancestor, such as a grandparent.) That is, the parsing of the reserved word “if” leads to the construction of a phrase which can be directly ingested into ATP, and which implements logic analogous to program branching. This strategy allows human natural language, with its high degree of ambiguity and context sensitivity, to be treated in a manner essentially akin to a structured computer language, allowing for the automation of a large number of tasks that could not be previously automated.

As such, as best understood, exemplary embodiments of the present system may operate to allow a robot to converse with human beings with understanding comparable to human comprehension. For example, according to an exemplary embodiment, a robot implementing a system such as the current system and which has generated (or which has access to) an appropriate ontology 212 may be asked highly detailed questions about subject matter in text, in such a manner as to enable the robot to respond in such a way as to demonstrate understanding as opposed to repeating back the literal text material, or searching a database for specific terms. Existing query and human interface systems are unable to conjecture, reason, or hypothesize, and can only respond to humans in simplistic ways. This is made possible by the processing of natural language into a format compatible with ATP and other inference engines, such that the stored information is represented as theorems and axioms, as opposed to XML and HTML web pages (such as might be retrieved as part of internet searching), and databases and class structures implemented in other languages. (However, in some circumstances, it may be contemplated to implement an object list in a similar file format, such as XML, JSON, or YAML, or in some other such similar format such as may be desired.) As such, data from outside sources can be rapidly ingested. In some exemplary embodiments, for example, web crawler programs may function to access web pages automatically, and ingest information from across the internet, demonstrating a level of comprehension and resilient concept-forming capability unavailable to robotic query systems today.

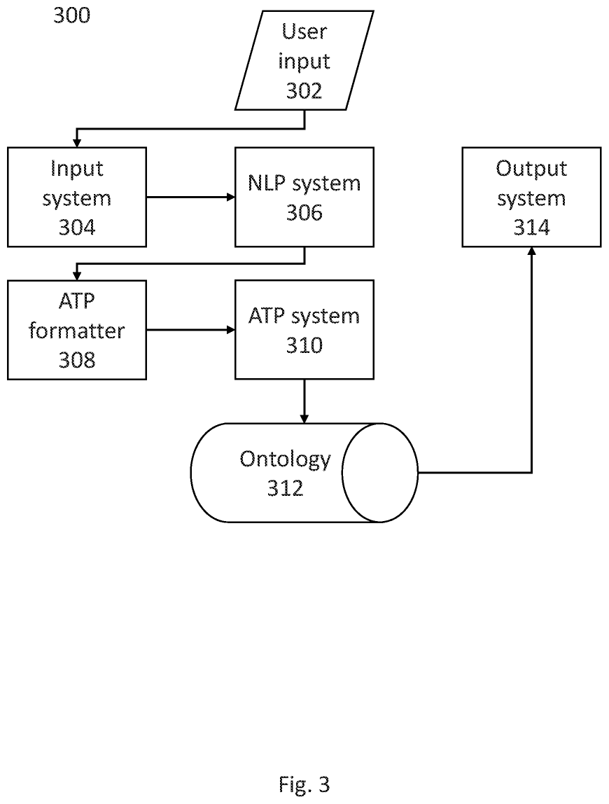

Turning now to exemplary FIG. 3, FIG. 3 provides an exemplary flowchart depicting an exemplary embodiment of a process for constructing and using an ontology with an automated ontology data comprehension system 300. In a first step, a user may provide input 302, which may be interpreted by an input system 304, such as a microphone for spoken language, a messaging system for messages provided by email, text message, and the like, or any other input system such as may be desired. (In some exemplary embodiments, non-text inputs, such as photographs, maps, diagrams, or video, and/or non-text outputs may also be contemplated. For example, according to an exemplary embodiment, a system may be employed as an instrumental musical composition system, with data provided to the system being audio tracks, and system outputs being composed sets of music based on some defining criteria provided as an input. Such a system may be used to, for example, automatically generate a background track for a movie trailer or other such video clip. In other exemplary embodiments, audio output using text-to-speech translation, or pictorial or video output representing the content of the logical system output, may also be contemplated. In other exemplary embodiments, audio input involving spoken language may be processed not only for text content, but for vocal inflections that indicate questioning, exclamation, or other emotional nuance or contextual content which may provide clues for structuring the translation to logical statements.) These multiple inputs may be processed simultaneously, in aggregation, or in combination using a process of data fusion.

The user input may be provided to an NLP system 306. (In some exemplary embodiments, such as if the system is configured to provide image inputs or outputs, the NLP system 306 may be another interpretation system appropriate to the content in question, such as may be desired.) The NLP system 306 may parse the provided data, as a first step of determining whether the user has provided a request to the system, and, if so, what the user has requested and what response is appropriate. The parsed data may then be provided to an ATP formatter 308 and matched against the ontology 312.

In some exemplary embodiments, the parsed data may be matched against the ontology 312 by an ATP system 310, which may also use the user query or other user statement to continue to build the ontology 312, if desired. In certain exemplary embodiments, it may be contemplated to have ontologies that are adjusted based on particular users and their queries, responses, and so forth over time; this may be used to train the system to do such things as interpret regional variations in speech that are used by the user or other similar users but would not have the same recognized meanings to other users. For example, “soda,” “pop,” and “COKE” may have different meanings depending on the locale or depending on the user, which may be used to specifically tailor the ontology.

Once the system 310 has matched a user query against the ontology 312 or has otherwise interpreted the user input 302, the system 310 may generate an output via an output system 314. For example, according to an exemplary embodiment, once the system has determined how to properly respond to a user statement, the system may generate a response to the user statement according to some criteria, which may for example be an audio output (such as an answer to a user question), a textual output (such as, again, an answer to a user question, in this case provided via textual message), a pictorial, diagrammatic, or video output representing the logical content of the output, an electronic output such as controlling a particular device (for example, the system may instruct a particular device to turn on or off, or perform certain commands such as changing a speed of a controllable motor, changing a temperature of an environment, changing the channel on a TV, and so on and so forth), or any other output or combination of outputs such as may be desired.

Various formats of input and output may be contemplated, and in some exemplary embodiments may not be confined to the same format. To briefly explore one example, according to an exemplary embodiment, a user may be able to instruct the system to “write a ‘thank you’ message to my guest.” The system may interpret “guest” in such a manner that it retrieves a calendar of a user and retrieves a record for a “visitor” who visited in the past hour, equates the two terms, and generates an automated “thank you” message based on a template. This may then be output to the user for final review.

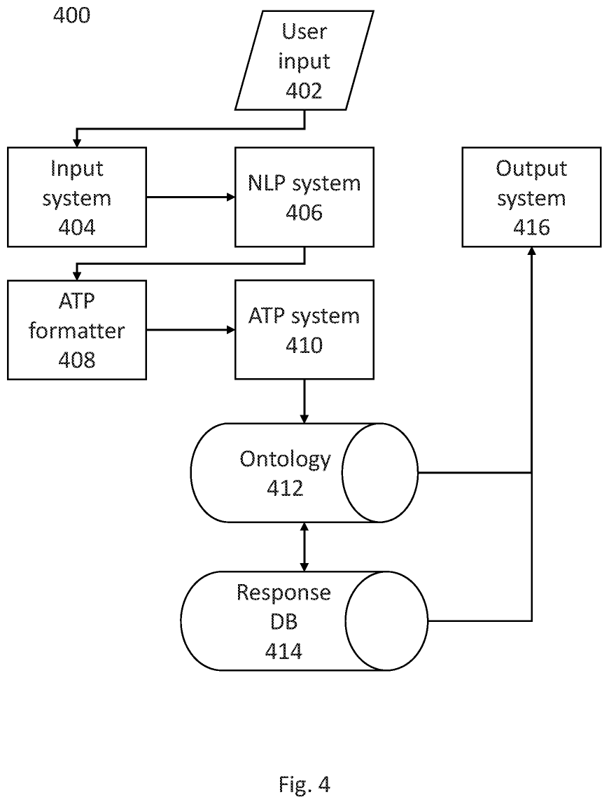

Turning now to exemplary FIG. 4, FIG. 4 is an exemplary flowchart depicting an exemplary embodiment of a process for constructing and using an ontology with an automated ontology system 400. According to an exemplary embodiment, a user may provide a user input 402, may have the input 402 interpreted through an input system 404, processed using a NLP system 406 or similar system (for example, for non-text inputs), provided to an ATP formatter 408, provided to an ATP system 410, and provided to an ontology 412. In FIG. 4, however, it may be contemplated that the system may be controlled to respond in particular ways, based on predetermined outputs saved in a response database 414, to particular questions, regardless of the exact wording of those questions. As such, the system may use the ontology 412 to interpret a query of a user, and, if the query matches a query in the response database 414, a saved response may be output via an output system 416. Otherwise, the system may use the ontology 412 to generate a response, which may then be provided via the output system 416.

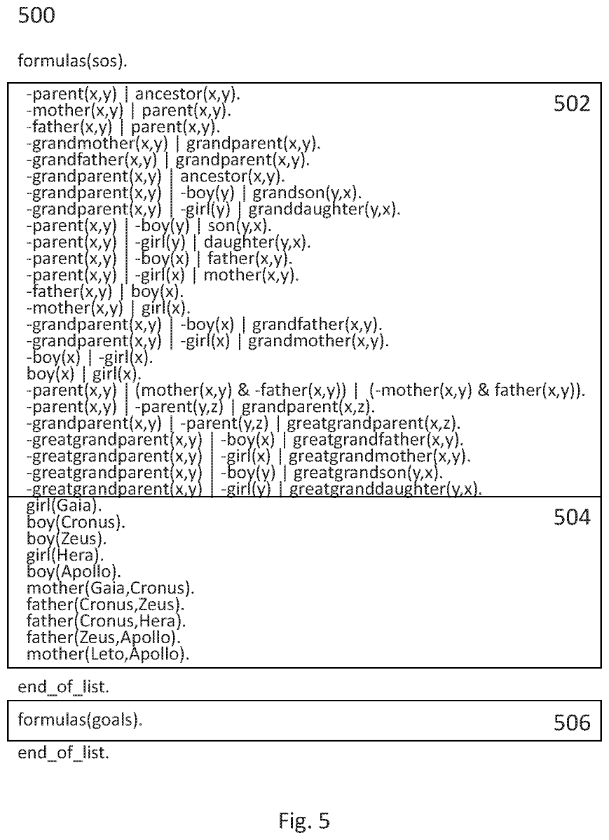

Turning now to exemplary FIG. 5, FIG. 5 depicts an exemplary embodiment of a set of computer code depicting an exemplary set of axioms that may be used in a conjecture generation program 500. According to an exemplary embodiment, the computer code may define a set of conjectures, including a first set of general linguistic rules 502 and a second set of relationship data 504. According to an exemplary embodiment, such general linguistic rules 502 and relationship data 504 may each be provided as axioms initially, and, as new theorems are proven, they may automatically be added to the represented knowledge base. For example, as provided therein, the general linguistic rules 502 may be, for example, a rule that a “parent” is an ancestor, a rule that a “mother” is a parent, a rule that a “father” is a parent, and so forth. Other rules may be, for example, a rule that a “mother(x, offspring)” may be a “girl(x),” and so forth. Likewise, various other inputs, in this case characterizing relationship data to be analyzed 504, may be added. This may define, for example, that “Gaia” is a “girl,” that “Cronus” is a “boy,” that “Gaia” is the “mother(x, offspring)” of “Cronus” (such that “mother (Gaia, Cronus)” is true), and so forth. This system may then be solved by the ATP program in a simple demonstration analogous to the generation of an ontology such as has been previously referenced. The system may also define that its goals 506 are to test one or more hypotheses related to a query or a problem, or generate a complete set of formulas, such that the status of each deity defined in the relationship data is fully characterized.

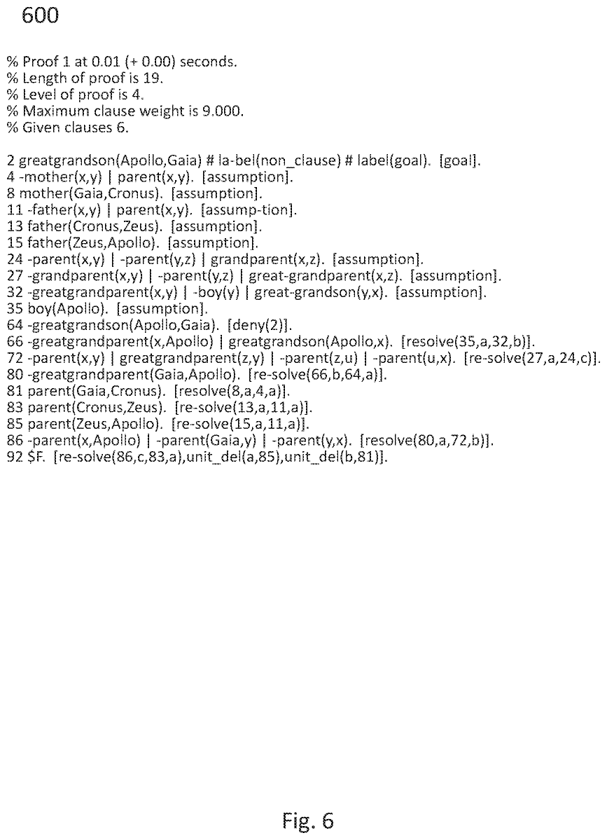

Turning now to exemplary FIG. 6, FIG. 6 displays an exemplary embodiment of a proof 600 generated by an automated theorem prover according to an exemplary embodiment of the present system. In an exemplary embodiment, the proof 600 may track the progress of the automated theorem prover and may demonstrate how the automated theorem prover came to its conclusions. For example, according to an exemplary embodiment, the proof may establish that “Apollo” is the “greatgrandson(x,y) of “Gaia” based on the below lines. This conjecture may be provided, in line 2, as a goal, which the system may then try to resolve. The system may begin with the assumption that a “mother(x,y)” is a “parent(x,y),” and then interpret the relationship data based on the assumption that Gaia is the mother of Cronus (“mother(Gaia,Cronus)”). The system may then take into account the other assumptions, determining that Cronus is the father of Zeus, and that Zeus is the father of Apollo, as well as all the other linguistic assumptions. The system may then use these data in order to establish that “-parent(x,y)|greatgrandparent(z,y)|-parent(z,u)|-parent(u,x).” That is, at least one of the set of the following must be true: “X being the parent of Y is not true;” “Z being the great-grandparent of Y is true,” “Z being the parent of U is not true,” or “U being the parent of X is not true,” such that if each of the “parent” statements are true (making X the parent of Y, U the parent of X, and Z the parent of U) Z may therefore be the great-grandparent of Y. As such, in order to resolve that Gaia is the great-grandparent of Apollo, it may be resolved that Gaia is the parent of Cronus (based on assumptions in line 4 and 8), that Cronus is the parent of Zeus, that Zeus is the parent of Apollo, and that therefore the above relation can be solved with Gaia being the great-grandparent of Apollo. The goal is thus reached, and the proof shows that Apollo is the great-grandson of Gaia. The same method may be used in order to resolve any of the other relationships, such as, for example, Cronus being the grandparent of Apollo, such as may be desired. Such a system may also work on more complex data sets, with more complex logic, operating according to the same principles or according to similar principles, such as may be desired.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

For example, in an exemplary embodiment, it may be contemplated to make use of another topological graph structure other than a tree structure, or some other kind of graph, such as may be desired. For reference, a topological graph is a representation of a graph in a plane such that the vertices of the graph are represented by distinct points joined by edges, which can be lines or arcs and which cross a finite number of times in such a manner that no edge passes through a vertex different from its endpoints. (These include “geometric graphs,” where the edges are line segments.) “Trees” are, specifically, undirected graphs in which any two vertices are connected by exactly one path; “forest” structures, in which any two vertices are connected by at most one path (and which may thus operate as a plurality of trees) may likewise be considered.

Various forms of automated solver software may be configured to make use of other graphs other than trees in alternative implementations. For example, in an exemplary embodiment, the system may be configured to implement a constrained search of a set of combinations of objects based on an adjacency table, or otherwise based on some other principles of graph theory. To provide a brief example, an adjacency table is a two-dimensional table in which a complete set of objects is listed in both the rows and columns of the table, and a numerical weight specifying some relationship value is placed at the intersections. For example, to describe the proximity of US cities to one another, one could list all the cities in the US in the rows and columns, and the intersection of each row and column could be the driving distance between the two cities. The same strategy could be used in order to measure the weight of the relationship between pairs of objects. According to an adjacency table design such as might be contemplated by a person of ordinary skill in the art for use with the present application, objects for conjecture could be chosen by sorting the table according to these weights, then choosing the highest-weighted objects for substitution into the generated conjecture. For example, if a theorem exists with “dogs” as an object, the substitution of “cats” as a conjecture may be generated if sufficient weight of relationship exists between the two concepts, based on the intersection between “cats” and “dogs.” (In an exemplary embodiment, such a graph may have different weights depending on the direction of substitution; for example, while “cats” may be interchangeable with “felines” and have approximately values for the weight of the relationship in each direction, this may not be the case for “dogs” and “canines,” as “dogs” may refer to additional concepts like being “dog tired” as noted above, while “canines” can additionally refer to teeth. However, if desired, a single relationship value can be used for each, such as a minimum relationship value for each potential substitution; for example, if “dogs” cannot be readily substituted for “canines,” “canines” will likewise not be readily substituted for “dogs.”)

For examples of other graphs besides trees that may be applied toward the process of conjecture generation or reducing the search space for theorem proving, a number of alternative topologies exist, such as small-world, star, and scale-free network topologies, which may be provided individually or in combination to implement one or more embodiments of the present structure. For reference, a small-world network is a network in which the shortest-path distance between nodes increases slowly as a function of the number of nodes in the network, such that even though most nodes are not neighbors of one another, the neighbors of any given node are likely to be neighbors of one another, such that most nodes can be reached from every other node by a small number of hops or steps. A star network topology is one in which each node is connected to some central connection point, like the points of a star, and might also be called a “spoke-hub” topology. A scale-free network topology is one in which a few nodes with many connections, “hub nodes,” are combined with a larger number of nodes that are primarily connected just to the hub nodes or which themselves form smaller hubs. (It is also possible for a network to demonstrate the properties of more than one of these network topologies at once, with a common example being a social influence map. For example, in the “Bacon number” phenomenon that is often used as an example of a scale-free network, actors may be characterized based around the degrees of separation that they have from the actor Kevin Bacon based on their collaboration with other actors in films. A little-known actor might have been in a film with a more famous actor, who serves as a “hub node,” and that “hub node” might have a connection to many other “hub nodes” that allow the desired end target to be quickly reached. For example, in one such progression, the desired end hub node (Kevin Bacon) may be linked to another hub (John Candy) who may be linked to a starting node (William Shatner), so William Shatner can be linked to Kevin Bacon by progressing through one intermediate hub. As such, the network as a whole can have “small-world” properties.)

To give an example of how this might be applied toward the process of conjecture generation or reducing the search space for theorem proving, a small-world network graph of relationships between objects in a knowledge base might imply that many of the objects are linked to one another; whereas, in a star network topology, there may be objects linked to central objects but not linked to one another. The topological configuration of data elements within the knowledge base would have implications for the efficiency of searching for likely conjectures; for example, searching for a hypothesis or theorem resolution within a small-world network topology might require testing each of the many interrelationships, whereas there may be little or no need to check for interrelationships among the outer elements in a star network. On the other hand, the small-world network topology might not require testing conjectures on objects outside the neighborhood of the small-world knowledge domain. Typical NLP output is structured like a tree, and hierarchies and taxonomies in ontologies often have tree-like structures; however, the linking of objects in multiple sentences within a document, and across multiple documents, could in principle generate more complex graph structures that could be implied for reasoning and conjecture generation. In contradistinction to conventional theorem provers, in an exemplary embodiment, it may be contemplated to make use of the system to generate its own conjectures and hypotheses, by traversing links across the topological graph structures of the knowledge base. In this capacity, the inference engine is not just seeking the resolution or proof of a theorem, but generating hypotheses in order to solve a problem, thus facilitating inductive or abductive reasoning as well as deductive reasoning.

To generate hypotheses and conjectures, in some possible exemplary embodiments, the system can be configured to apply methods of Knowledge Base Completion, such as graph neural networks and tensor completion. For example, using the notation of R(S,O) to signify relation R as a theorem operating on subject S and object O, the tuple can be framed as a universe of relationships, s^{T} M_{R} o, where s^{T} is a column vector representing possible subjects, o is a vector representing possible objects or predicates, M_{R} is a matrix representing the graph of possible relationships between those entities. Knowledge Base Completion techniques make it possible to infer new tuples (which, as has been described before, may themselves include subjects and predicates with their own compound structure). Using such methods, which are often inherently amenable to parallel computing and other hardware efficiencies, it is possible to generate new tuples, and in so doing, increase the size, density, fidelity, and generality of the graph structure of the knowledge base. For example, searches, evaluation of axioms, and construction of many edges and nodes can be performed simultaneously in parallel by hardware such as supercomputers and other parallel-processing devices. Though the methods described here are intended to provide more precise comprehension than is possible with currently available CNNs and deep learning, the traversal and construction of graph structure data representing the axioms may make use of CNNs and deep learning in various exemplary embodiments. It should be noted that there are many possible methods for carrying out Knowledge Base Completion and hypothesis generation, and the several methods mentioned here represent only a few of the many possible techniques which can be applied by various exemplary embodiment provided herein.

In various exemplary embodiments, the weights between objects (which may determine which objects are tested for conjecture generation, and in what order) may be measured in a variety of ways. For example, in various exemplary embodiments, word vectors, word embeddings, clustering, and N-grams can be used to measure the co-occurrence of words in input documents used to generate theorems. Co-occurrence of Objects with Objects, Objects with Features, Features with Features, and Theorems with Theorems can all be described in this way. The number of co-occurrences, or some similar metric, can be used to set the weights of whatever graph structure is used to contain the possible objects for concept generation. Another mechanism for setting the weights of relationship may be to apply a priori values set by a user. That is, the user can constrain the knowledge domain to a subset of the larger corpus of information. There are various mechanisms for accomplishing this, for example, applying subset constraints to the Object and Feature fields in the previously given sample notation.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for automatically generating a response to a user query, comprising:
obtaining a first set of rules defining a knowledge domain;
obtaining a data file of ingestible information;
with a processor, generating a topological graph structure based on the ingestible information, and converting the topological graph structure into at least one topological graph structure logic axiom, the topological graph structure logic axiom being at least a first-order logic axiom;
storing a plurality of logic axioms in a memory, the plurality of logic axioms comprising the at least one topological graph structure logic axiom, each of the plurality of logic axioms being at least a first-order logic axiom;
with the processor, parsing further extrinsic information and formulating and testing one or more conjectures based on the further extrinsic information, the one or more conjectures comprising a logic axiom of at least first-order, wherein formulating and testing the one or more conjectures comprises generating, based on a combination of at least two of the plurality of logic axioms, at least one intermediate theorem, and generating, based on the plurality of logic axioms and the at least one intermediate theorem, a conjecture test result, the conjecture test result being an indication that a conjecture in the one or more conjectures is one of provable as true or not provable as true;
when the conjecture in the one or more conjectures is provable as true, storing the conjecture in the memory in the form of an ontology;
when the conjecture is not provable as true, formulating and testing one or more additional conjectures;
receiving, from an input system, the user query;
with the processor, mapping the user query to the ontology; and
generating, based on the user query and the ontology, the response to the user query.

2. The method of claim 1, wherein the data file of ingestible information comprises text data; and
wherein the topological graph structure is a natural language processing (NLP) topological graph structure representing at least one phrase and comprising a plurality of pairings of syntactic categories and words in the text data.

3. The method of claim 2, wherein the step of converting the topological graph structure into at least one topological graph structure logic axiom comprises:
identifying an action concept in the topological graph structure, wherein said action concept includes at least one of a verb, a verb phrase, a condition or state of being, and a system-specific operator, and automatically creating a theorem based on the action concept;
identifying a subject in the topological graph structure, and adding it to a multi-element data structure;
identifying a predicate in the topological graph structure, and adding it to the multi-element data structure; and
providing the theorem as a topological graph structure logic axiom of the form “action concept(multi-element data structure).”

4. The method of claim 2, wherein the step of converting the topological graph structure into at least one topological graph structure logic axiom comprises:
identifying an action concept in the topological graph structure, wherein said action concept includes at least one of a verb, a verb phrase, a condition or state of being, and a system-specific operator, and automatically creating a theorem based on the action concept;
identifying a subject concept in the topological graph structure, and adding it as an object in a multi-element data structure;
identifying a predicate concept in the topological graph structure, and adding it as an object in the multi-element data structure;
identifying at least one modifier of at least one of the subject or predicate, and adding the at least one modifier as a feature in the multi-element data structure in association with the at least one of the subject or predicate; and
providing the theorem as a topological graph structure logic axiom of the form “action concept(multi-element data structure),” wherein the multi-element data structure comprises at least one object-feature pairing.

5. The method of claim 4, wherein the multi-element data structure is variadic.

6. The method of claim 4, wherein the multi-element data structure comprises at least one of: an iterative concept pairing, and a recursive concept pairing.

7. The method of claim 1, wherein the data file of ingestible information comprises at least one of audio data, image data, mapping data, diagram data, or video data.

8. The method of claim 1, wherein the method further comprises mapping, with the processor, speech data to text data; and
wherein the topological graph structure is a natural language processing (NLP) topological graph structure comprising a plurality of pairings of syntactic categories and words in the text data.

9. The method of claim 1, wherein the user query is added to the data file of ingestible information.

10. The method of claim 1, wherein the method further comprises:
conducting, with the processor and via a network connection, at least one automated web search, and retrieving content from at least one web page; and
adding the content to the data file of ingestible information.

11. An automated ontology system configured to automatically generate a response to a user query, the system comprising an input system, an output system, a processor, and a memory, wherein the system is configured to perform the steps of:
obtaining a first set of rules defining a knowledge domain;
obtaining a data file of ingestible information;
with the processor, generating a topological graph structure based on the ingestible information, and converting the topological graph structure into at least one topological graph structure logic axiom, the topological graph structure logic axiom being at least a first-order logic axiom;
storing a plurality of logic axioms in the memory, the plurality of logic axioms comprising the at least one topological graph structure logic axiom, each of the plurality of logic axioms being at least a first-order logic axiom;
with the processor, parsing further extrinsic information and formulating and testing one or more conjectures based on the further extrinsic information, the one or more conjectures comprising a logic axiom of at least first-order, wherein formulating and testing the one or more conjectures comprises generating, based on a combination of at least two of the plurality of logic axioms, at least one intermediate theorem, and generating, based on the plurality of logic axioms and the at least one intermediate theorem, a conjecture test result, the conjecture test result being an indication that a conjecture in the one or more conjectures is one of provable as true or not provable as true;
when the conjecture in the one or more conjectures is provable as true, storing the conjecture in the memory in the form of an ontology;
when the conjecture is not provable as true, formulating and testing one or more additional conjectures;
receiving, from the input system, the user query;
with the processor, mapping the user query to the ontology; and
generating, based on the user query and the ontology, the response to the user query, and outputting the response to the user query via the output system.

12. The system of claim 11, wherein the data file of ingestible information comprises text data; and
wherein the topological graph structure is a natural language processing (NLP) topological graph structure representing at least one phrase and comprising a plurality of pairings of syntactic categories and words in the text data.

13. The system of claim 12, wherein the step of converting the topological graph structure into at least one topological graph structure logic axiom comprises:
identifying an action concept in the topological graph structure, wherein said action concept includes at least one of a verb, a verb phrase, a condition or state of being, and a system-specific operator, and automatically creating a theorem based on the action concept;
identifying a subject in the topological graph structure, and adding it to a multi-element data structure;
identifying a predicate in the topological graph structure, and adding it to the multi-element data structure; and
providing the theorem as a topological graph structure logic axiom of the form “action concept(multi-element data structure).”

14. The system of claim 12, wherein the step of converting the topological graph structure into at least one topological graph structure logic axiom comprises:
identifying an action concept in the topological graph structure, wherein said action concept includes at least one of a verb, a verb phrase, a condition or state of being, and a system-specific operator, and automatically creating a theorem based on the action concept;
identifying a subject concept in the topological graph structure, and adding it as an object in a multi-element data structure;
identifying a predicate concept in the topological graph structure, and adding it as an object in the multi-element data structure;
identifying at least one modifier of at least one of the subject or predicate, and adding the at least one modifier as a feature in the multi-element data structure in association with the at least one of the subject or predicate; and
providing the theorem as a topological graph structure logic axiom of the form “action concept(multi-element data structure),” wherein the multi-element data structure comprises at least one object-feature pairing.

15. The system of claim 14, wherein the multi-element data structure is variadic, and comprises at least one of: an iterative concept pairing, and a recursive concept pairing.

16. The system of claim 11, wherein the system further comprises at least one of: a connection to a computer vision system, and a connection to a speech recognition system;
wherein the data file of ingestible information comprises at least two data types associated with one another, said at least two data types comprising at least two of the set of: text data, audio data, image data, mapping data, diagram data, and video data; and
wherein the system is configured to synthesize the at least two data types based on an association of the at least two data types with one another.

17. The system of claim 11, wherein the system is further configured to map, with the processor, the speech data to text data; and
wherein the topological graph structure is a natural language processing (NLP) topological graph structure comprising a plurality of pairings of syntactic categories and words in the text data.

18. The system of claim 11, wherein the system is further configured to add the user query to the data file of ingestible information.

19. The system of claim 11, wherein the system is further configured to:
conduct, with the processor and via a network connection, at least one automated web search, and retrieve content from at least one web page; and
adding the content to the data file of ingestible information.

20. A non-transitory computer-readable medium comprising computer program code that, when executed, causes a computer system comprising an input system, an output system, a processor, and a memory to perform the steps of:
obtaining a first set of rules defining a knowledge domain;
obtaining a data file of ingestible information;
with the processor, generating a topological graph structure based on the ingestible information, and converting the topological graph structure into at least one topological graph structure logic axiom, the topological graph structure logic axiom being at least a first-order logic axiom;
storing a plurality of logic axioms in the memory, the plurality of logic axioms comprising the at least one topological graph structure logic axiom, each of the plurality of logic axioms being at least a first-order logic axiom;
with the processor, parsing further extrinsic information and formulating and testing one or more conjectures based on the further extrinsic information, the one or more conjectures comprising a logic axiom of at least first-order, wherein formulating and testing the one or more conjectures comprises generating, based on a combination of at least two of the plurality of logic axioms, at least one intermediate theorem, and generating, based on the plurality of logic axioms and the at least one intermediate theorem, a conjecture test result, the conjecture test result being an indication that a conjecture in the one or more conjectures is one of provable as true or not provable as true;
when the conjecture in the one or more conjectures is provable as true, storing the conjecture in the memory in the form of an ontology;
when the conjecture is not provable as true, formulating and testing one or more additional conjectures;
receiving, from the input system, the user query;
with the processor, mapping the user query to the ontology; and
generating, based on the user query and the ontology, the response to the user query, and outputting the response to the user query via the output system.
